(19) United States
(12) Patent Application Publication
(10) Pub. No.: US 2002/0132354 A1
(43) Pub. Date: Sep. 19, 2002

(54) Automated centrifuge and method of using same

(75) Inventors: Robert C. Downs, La Jolla, CA (US); Scott A. Lesley, San Diego, CA (US); James K. Mainquist, San Diego, CA (US); Andrew J. Meyer, San Diego, CA (US); Christopher M. Shaw, San Diego, CA (US); Mark R. Weselak, San Diego, CA (US); Marc Nasoff, San Diego, CA (US)

Correspondence Address: QUINE INTELLECTUAL PROPERTY LAW GROUP, P.C., P O BOX 458, ALAMEDA, CA, 94501, US

(73) Assignee: IRM, LLC C/O Sophia House, Hamilton (BM)

(21) Appl. No.: 10/071,877

(22) Filed: Feb. 8, 2002

Related U.S. Application Data
(63) Continuation-in-part of application No. 09/780,589, filed on Feb. 8, 2001.

(51) Int. Cl. G01N 35/00; G01N 9/30

(52) U.S. Cl. 436/45; 422/72; 422/101; 436/177

(57) ABSTRACT

An automated centrifuge comprising a rotor having a plurality of sample receiving elements located in the rotor is provided. Sample processing components are structured to be insertable into any one of the receiving elements and a controller is configured to insert the sample processing components into the sample receiving elements. The sample receiving elements located in the rotor are grouped in clusters, and the cavities of each cluster are substantially parallel. Also, an automated centrifuge system comprising a rotor including a plurality of clusters of receiving elements, each element including a longitudinal axis, with the longitudinal axes of each element in a cluster being substantially parallel is provided. A plurality of sample processing components are arranged in groups, with each group configured to be received into adjacent clusters. A rotor position member is structured to determine the position of each cluster. A controller directs the sample receiving elements into adjacent clusters, and directs the rotor position member to rotate the rotor to position clusters relative to sample processing component groups.

### CROSS REFERENCE TO RELATED APPLICATIONS

The present application is related to and claims priority to U.S. Ser. No. 09/780,589 to Downs et al. “Automated Centrifuge and Method of Using Same,” pursuant to 35 USC § 119 and/or § 120 or any other applicable statute or rule. This prior application is incorporated by reference in its entirety for all purposes.

### FIELD OF THE INVENTION

The present invention relates to the field of centrifuge technology. More particularly, the present invention relates to an automated centrifuge that is compatible with a multiple process operation such as a high throughput system.

### BACKGROUND OF THE INVENTION

Centrifugation is a key technology in many fields and industries. It is performed, e.g., at both mass production and experimental (e.g., bench top) scales. For example, centrifuges are used in a wide variety of disciplines, including the chemical, agricultural, medical and biological fields. In particular, centrifuge technology is integral to chemical syntheses, cell separations, radioactive isotope analyses, blood analyses, assaying techniques, as well as many other scientific applications.

The recent identification of the more than 140,000 genes comprising the human genome highlights one important use of centrifuge technology, namely the determination of each gene's function, which has become of paramount importance. Because each gene makes at least one protein, more than 140,000 proteins must be grown and isolated to understand the function of each gene in the human genome. Centrifugation is an important step in isolating and separating proteins, but protein isolation frequently requires several labor intensive and time-consuming sequential procedures that often involve more than one centrifugation step for each isolation process.

Particularly for commercial applications, these proteins and other products utilizing centrifuge technology must be synthesized, analyzed or isolated on a production scale. Production scale processes emphasize limited human intervention and automated processes to increase output and efficiency. In an assembly line fashion, automated equipment enables high throughput processing of industrial scale amounts of material, without disrupting the synthesizing, analyzing, or isolating process at each individual processing step. For example, automated liquid dispensers, aspirators, and specimen plate handlers facilitate the handling and testing of hundreds of thousands of samples per day with limited human interaction with the actual sample from beginning to end of the entire analysis process. In a further example, sample materials are automatically dispensed into multiple well specimen plates, reagents are added and removed via automated liquid dispensers and aspirators, and the specimen plates are transferred to each successive processing station by automated plate handlers. This increased production efficiency is premised in part on the viability of conducting the entire production process in the specimen plate. Similarly, automated procedures enable the synthesis of commercial pharmaceuticals from starting reagents to finished products without disrupting the production process with cumbersome, inefficient steps, such as changing a sample vessel, or transferring the sample vessels to another processing station.

Likewise, rapid advances in laboratory equipment have transitioned traditional laboratory bench top processes to more automated high-throughput systems. Unfortunately, limits in current centrifuge technology prevent the uninterrupted processing flow that characterizes automated high throughput systems.

These, and other disadvantages are highlighted in a typical protein isolation process. Generally, a sample is centrifuged, removed from the centrifuge and a portion of the sample is removed, often by aspiration, from the sample at a separate processing station. At yet another processing station, a reagent is often dispensed into the remaining sample, followed by sonication or mixing in a separate sonication or mixing device (also at another processing station). Once the contents of the sample have been sonicated or mixed, the sample is placed back in the centrifuge and undergoes another centrifugation step. Frequently, this centrifugation-aspiration-dispensing-sonication/mixing-centrifugation cycle is repeated more than once for a particular protein isolation.

This cycle and all its drawbacks are also representative of many other applications involving centrifugation. Disadvantageously, typical sonication and centrifugation steps are not amenable to automated processing flows, because of the need to physically transfer large numbers of samples to and from various processing stations. For example, in the example described above, a sample must be moved from a centrifugation station to an aspirating station, to a dispensing station, to a sonication station, and back to a centrifugation station. Unfortunately, this cycle may be repeated several times before a particular protein or other targeted material is isolated. Accordingly, the labor-intensive nature of the isolation process poses severe time constraints and process costs, particularly as integration of the centrifugation step or the sonication step into an automated multiple process system is currently unavailable.

As centrifugation remains a key processing step in a number of industries, and particularly in biotechnology industries, a critical need exists for incorporating centrifugation processes into current multiple process systems, such as automated high throughput systems. Developing a method and apparatus that reduces the need to transfer samples to a separate processing station for each processing step is useful in integrating centrifugation into modem production processes in an automated high throughput system.

### SUMMARY OF THE INVENTION

The present invention provides automated centrifuge systems, new rotor designs and methods of using these systems and rotors. The centrifuge systems provide for sample processing of sample vessels while they are within a rotor. Optionally, the rotors are designed to facilitate sample processing, e.g., by including clusters of sample receiving elements that have substantially the same vertical axis (e.g., in a fixed angle rotor), facilitating insertion of sample processing components into the sample vessels. The centrifuge system typically includes an indexing system which permits precise rotational positioning of the rotor, also facilitating insertion of the sample processing components into the sample vessels. This indexing system can use the same motor for both centrifugation and rotor positioning, e.g., when coupled to an appropriate control system, or can use different motors to perform these functions. The system can also include appropriate robotics for loading sample vessels into the rotor. The speed of the robotic operation can be improved by using robotics that insert multiple sample vessels simultaneously into the clusters, an operation facilitated by the vertical axis alignment of sample receiving elements in the rotors.

The centrifuge system can include any of a variety of upstream or downstream sample processing components, e.g., facilitating generation of samples to be centrifuged (e.g., automatic fermentation systems) or processing of materials removed from sample vessels after centrifugation, e.g., sample purification components. These upstream or downstream processing components can be part of the centrifuge systems of the invention, or can be separate systems that operably interact with the centrifuge system.

Accordingly, in one embodiment, the invention provides an automated centrifuge system. The system includes (a) at least a first rotor comprising a plurality of sample receiving regions and, (b) at least one transport mechanism configured to move one or more sample processing components proximal to or within the plurality of sample receiving regions. Additionally or alternatively to (b), the system can include at least one robot capable of inserting at least two sample vessels into the sample receiving regions at substantially the same time.

Optionally, the rotor comprises or is operably coupled to a rotor position sensor which determines the relative position of the sample receiving elements. The rotor position sensor can be any suitable indexing system, e.g., using a rotary magnetic or optical encoder. In these embodiments, the rotor comprises or is operably coupled to a reference index which facilitates positioning of a cluster of sample receiving elements in the rotor relative to a group of sample processing components coupled to the transport. In one embodiment, the system comprises a first motor which spins the rotor to position the clusters according to the reference index. While the system optionally comprises a second motor which spins the rotor during sample centrifugation, in one aspect the first motor is also configured to spin the rotor during sample centrifugation.

Most typically, the automated centrifuge system sample receiving regions are configured to receive a centrifuge tube. However, other embodiments are also applicable, e.g., where the sample receiving regions receive a rack, a microtiter dish, or the like. In certain preferred embodiments, the sample receiving regions are arranged in clusters, with each sample receiving region in a given cluster comprising a longitudinal axis substantially parallel to other sample receiving regions in the cluster. Typically, the sample receiving regions are arranged in a plurality of clusters each comprising a plurality of sample receiving regions, each sample receiving region in each cluster having substantially parallel longitudinal axes. The number of sample receiving elements in a cluster can vary, e.g., from about 2 to about 10 sample receiving elements. For example, in one embodiment, the clusters of a rotor each comprise at least about four sample receiving elements.

Typically, the rotor is mounted within a centrifuge chamber comprising a rotor cover configured to mate with a top surface of the centrifuge chamber. In certain embodiments, additional features are mounted on top of the rotor cover, e.g., which can be moved relative to the rotor by moving the cover relative to the chamber.

In the automated centrifuge system, the system typically comprises a group of sample processing components. The transport is configured to substantially simultaneously insert the group of sample processing components into a cluster of sample receiving regions. Optionally, the group of sample processing components perform at least 2 different sample processing operations, simultaneously or serially, in the clusters. For example, the group of sample processing components can perform sample processing operations on at least about 3, at least about 4, at least about 6, at least about 8, at least about 16, or at least about 32 different samples at the same time. In one configuration, the group of sample processing components are arranged in at least two groups of components, wherein each group is configured to be inserted into adjacent clusters of sample receiving elements. Optionally, the sample processing components can be arranged in more than 2 groups of components, e.g., at least about 3, at least about 4, at least about 6, at least about 8, at least about 16, or at least about 32 groups of components.

The sample processing components can perform any desired sample treatment processing function, e.g., the components can comprise one or more sample processing component configured to transport at least one fluid to or from the sample receiving elements (which optionally include centrifuge vessels inserted therein). In one aspect, the sample processing components are configured to selectively perform an operation such as: aspiration of material away from at least one of the sample receiving elements, dispensation of material into at least one of the sample receiving elements, vibration of a material in at least one of the sample receiving elements, measurement of a property of a material in at least one of the sample receiving elements, aspiration of material away from a cluster of sample receiving elements, dispensation of material into a cluster of sample receiving elements, vibration of a material in a cluster of sample receiving elements, and/or measurement of a property of a material in a cluster of sample receiving elements.

The configuration of the sample processing components, accordingly, varies according to the sample operation to be performed. For example, the sample processing components can comprise one or more sample processing component such as: a fluid aspiration tube, a fluid dispensing tube, a rigid tube, a flexible tube, a vibrating member, and/or a sonication rod. For example, in one embodiment, a plurality of the sample processing components in the group together comprise a plurality of sonication rods configured to be inserted into the sample receiving regions and/or a plurality of tubes configured to transport at least one fluid to or away from the sample receiving regions. As noted, the rotor typically includes clusters of sample receiving elements. These can be arranged, e.g., in pairs of components, so that when a sample processing group is moved into a first cluster of sample receiving elements, at least one pair of sample processing components is inserted into at least one pair of corresponding sample receiving elements in the cluster.

As noted, the system can include robotics for delivering sample vessels to the rotor. For example, in one embodiment, the at least one robot comprises a gripper mechanism configured to grasp the outside surface of a sample vessel to be inserted into the sample receiving regions. In an alternate embodiment, the robot comprises a gripper mechanism configured to grasp the inside surface of a sample vessel to be inserted into the sample receiving regions. The robotic elements optionally provide for capping and uncapping of sample vessels where desired, although, in many cases, sample vessels are spun without capping (thereby increasing system throughput). In a preferred embodiment, the sample receiving elements are arranged in clusters and the robot is configured to position at least 2 centrifuge vessels into receiving elements in at least one cluster at the same time. For example, in one embodiment, the sample receiving elements are arranged in clusters and the robot is configured to position at least about 4, at least about 8, at least about 16, or at least about 32 centrifuge vessels into receiving elements in at least one cluster at the same time.

Similarly, in a preferred embodiment, the robot is capable of removing sample vessels from the rotor. For example, the robot, in one embodiment, is configured to remove a plurality of sample vessels from a plurality of sample receiving elements at the same time.

In one aspect, the system further comprises system software or other logic which controls rotation of the rotor relative to the robot such that the robot is capable of positioning centrifuge vessels into sample receiving elements of different clusters of the centrifuge rotor. In one aspect, the system comprises at least one controller operably coupled to the transport, the robot, or both the transport and the robot, where the controller is configured to perform at least one operation such as: directing the transport to deliver one or more materials to the one or more sample receiving regions, directing the robot to deliver a plurality of sample vessels to the sample receiving regions, and/or directing the transport to move the sample processing components proximal to or within the sample receiving regions.

For example, in one aspect, the controller directs the transport to insert a plurality of the sample processing components into the plurality of sample receiving regions. For example, where the rotor comprises a cluster of sample receiving elements and the transport is coupled to a group of sample processing components, the controller can direct the transport to insert the group of sample processing components into the cluster of sample receiving elements. The controller, which may be a single control element such as a single computer, or a network of interconnected control elements, can comprise one or more controller components such as: a computer, a programmable logic controller, system software, a user interface, and/or a network of computers. In one aspect, the controller is configured to control rotation of the rotor. In another aspect, the controller is configured to control positioning (e.g., rotational positioning) of the rotor. Positioning can be assisted using an index (e.g., an optical or magnetic system that aids in tracking rotor position), where the controller references the index to position a cluster of sample receiving elements relative to a set of sample vessels or relative to a set of sample processing components, or both.

In another aspect, the controller directs the transport to insert and remove a group of sample processing components into a cluster of sample receiving elements. The controller, or a separate controller can further direct a rotor positioning mechanism (e.g., comprising a motor) to rotate the rotor relative to the group of sample processing components until another cluster is proximal to the group. For example the controller (which can be a single controller or a system of controllers) can direct the transport to insert and remove groups of sample processing components into adjacent clusters of sample receiving elements, and can further directs a rotor positioning mechanism to rotate the rotor relative to the groups until another cluster or pair of adjacent clusters is proximal to the groups. The controller optionally includes system software which controls rotation of the rotor relative to the robot, or the transport, or both the robot and the transport, such that the robot is capable of positioning vessels in the rotor or such that the transport is capable of inserting sample processing components into the sample receiving elements, or both.

In one embodiment, the automated centrifuge system includes a pair of operator safety members (e.g., pressure sensor switches) that communicate with the controller, wherein the members, when activated, permit rotation of the rotor. For example, the pair of operator safety members can be selected from the group consisting of: a pair of switches, a pair of buttons, and/or a pair of touch buttons. Thus, in a preferred embodiment, the operator must place both hands on the operator safety members before the controller will engage the rotor motor. This ensures that the operator's hands are free of the rotor motor, preventing injury to the operator by the rotor.

In one embodiment, the automated centrifuge system comprises means for recognizing a sample or sample vessel when the sample or sample vessel is moved to the sample receiving region, means for recognizing the sample processing component when the sample processing component is moved proximal to or within the sample receiving region, or both, and an indexing means for tracking the sample, the sample processing component, or both, when the sample or sample processing component is moved from the sample receiving region to a different region of the automated centrifuge system, or to a separate system or device.

In one aspect, the system includes logic (e.g., a computer, system software, controllers, PLCs, databases, or the like) that tracks which sample vessels are located in which sample receiving elements. In addition, or separately, the system can further include logic for tracking what sample processing operations are performed on a sample or sample vessel.

In one aspect, the automated centrifuge system includes one or more sample vessels structured to be insertable into at least one of the sample receiving regions. The one or more vessel can contain one or more sample and can comprise one or more mating feature which mates with a corresponding mating feature of the robot (e.g., the vessel can be a centrifuge tube that includes a lip that can be grasped by a grasping robotic mechanism).

In one aspect, the automated centrifuge system includes multiple rotors, transport elements and the like. For example, the system can include a second rotor that comprises a cluster of sample receiving elements and a movable platform coupled to the transport or the robot. The movable platform can move the transport or the robot to selectively position the sample vessels, the sample processing components, or both, for insertion of the sample vessels, the sample processing components, or both, into the sample receiving elements of the first rotor or the cluster of sample receiving elements in the second rotor, or both.

In one aspect, the automated centrifuge system of includes a rinse container structured to contain a fluid. The rinse container is configured to accept the sample processing components, e.g., where the transport positions the sample processing components in the rinse container, thereby rinsing the components. For example, the rinse container can include a tube bin, a rod bin and a runoff ramp.

In one embodiment, the sample processing components are configured to remove a material from the sample receiving regions. For example, in one embodiment, the sample processing components are fluidly coupled to a sample purification component such as a fraction/specimen collector, purification column, array of purification columns, resin bed, nickel chelate resin bed, filter bed, a filter, a nitrocellulose filter, a vessel, a resin, a resin bed, an ion-exchange resin, a hydrophobic interaction resin, a sizing column and/or the like. During operation of the system, material is optionally flowed from the sample processing component to a sample purification component such as a the specimen collector. The collector optionally comprises a fraction dispensing element, a resin bed into which material can be flowed from the fraction dispensing element, a collection tube rack which collects material from the resin bed, and a waste collection tray coupled to a waste dump.

Any component of the system, or, indeed, the entire system, can be refrigerated (or otherwise regulated according to temperature, humidity, CO₂ content, O₂ content, or the like). This aids in preserving sample components, or e.g., in maintaining a physiological condition of a biological component (e.g., in keeping cells alive prior to processing). For example, where the system includes a specimen collector or a rotor, the specimen collector or the rotor or both are optionally refrigerated.

The systems can include additional transports or other robotics. For example, the system can include at least a second transport configured to transport a second group of sample processing components that can be inserted into one or more rotors of the system.

Thus, in one embodiment, the system includes one or more sample processing components. In one example, one or more hoses are coupled to the sample processing components. These components are configured to receive material transported from the sample receiving regions through the sample processing components. One or more tips are coupled to the one or more hoses, and a pump is operatively coupled to the one or more hoses or to the one or more tips. A fluid source is fluidly coupled to the sample processing elements. A specimen collector is arranged to receive material from the one or more tips. A switch controls fluid flow between the fluid source and the sample processing elements or between the sample processing elements and the hoses or tips. The system also includes a waste dump configured to receive waste from the sample processing elements, the fraction collector, the tips, the hoses, the sample processing components, the sample receiving elements, vessels inserted into the sample receiving elements, the fluid source, or any combination thereof.

In general, the automated centrifuge system set forth above typically includes a centrifuge.

In addition to the automated centrifuge system set forth above, the invention includes any of a variety of centrifuge rotors. The rotors of the invention typically include a rotor body comprising at least one cluster of sample receiving elements disposed therein, e.g., with the sample receiving elements in a fixed arrangement. The cluster comprises a plurality of sample receiving elements comprising substantially parallel longitudinal axes. In general, the longitudinal axes of the elements are not completely vertical, e.g., at least about 1° off of vertical, or at least about 5° off of vertical. In one example embodiment herein, the axes of the elements are about 30° (e.g., 32°).

In general, the clusters comprise spatially grouped sample receiving elements. The rotor body typically comprises a plurality of clusters, each comprising a plurality of sample receiving elements comprising substantially parallel longitudinal axes. There can be a large variety of numbers of sample receiving elements in the clusters, depending, e.g., on the size of the elements and the size of the rotor. For example, in one class of embodiments, there are between about two and about ten sample receiving elements in the cluster. This can include, e.g., between about 10 and about 200 sample receiving elements in the rotor body. In one embodiment, there are between about 8 and about 40 clusters of sample receiving elements in the rotor body, each comprising a plurality of sample receiving elements comprising substantially parallel longitudinal axes.

As noted, the size of the receiving elements can influence the number and shape of the clusters. For example, in one aspect, the sample receiving elements are each capable of housing a vessel having a volume of at least about 10 mL. In another, the volume is at least about 100 mL. In general, the sample receiving elements are typically configured to accept a centrifuge tube, though they can be configured to accept alternate arrangements of elements, e.g., plates or the like. In addition, the cluster of sample receiving elements are typically arranged to substantially simultaneously receive a group of movable sample processing components held by a transport.

In addition to rotors and systems, the invention provides methods, e.g., of using the rotors and systems. For example, in one aspect, the invention provides methods of treating one or more samples in a centrifuge rotor. The methods include: (a.) placing a sample into a sample vessel; (b.) inserting the sample vessel into a centrifuge rotor; (c.) rotating the rotor, thereby centrifuging the sample in the sample vessel; and, (d.) performing one or more sample treatment operation on a component of the sample in the vessel, while the vessel is inserted into the centrifuge rotor. The order of the above steps can be varied, e.g., step (a.) can be performed before or after (b.). Typically, (b.) includes placing a plurality of vessels into the centrifuge rotor.

In one embodiment, (d.) includes at least one sample treatment operation, such as: aspirating supernatant from the vessel while the vessel located in the centrifuge rotor, delivering fluid to the vessel while the vessel is located in the centrifuge rotor, and/or sonicating the component within the vessel while the vessel is located in the centrifuge rotor cavity. (d.) optionally includes removing a material from the vessel while the vessel is located in the centrifuge rotor cavity and depositing the material into a specimen collector. In one embodiment, (d.) includes performing at least two different operations on at least two different sample vessels, where the operations include, e.g., dispensing fluid into at least one of the sample vessels, suspending a sample component in at least one of the sample vessels, and/or aspirating fluid from at least one of the sample vessels. Optionally, (d.) includes simultaneously performing a plurality of operations on a plurality of sample components distributed in a plurality of sample vessels. Similarly, (d.) optionally includes simultaneously performing a plurality of different operations on a plurality of sample components distributed in a plurality of sample vessels.

The methods can include further steps, such as transporting a sample component from the vessel, while the vessel is located in the centrifuge rotor, to a specimen or fraction collector, or to a sample purification component. Any of the above described features of the fraction collector can be present in this method.

Similarly, the methods can further include, e.g., recognizing the vessel when the vessel is inserted into the rotor and tracking the vessel when it is transferred from the centrifuge rotor to a separate system or device.

The sample vessel can be inserted into the rotor with a robot. The sample treatment operations can be performed with one or more sample treatment components which are coupled to a transport.

In another aspect, the invention can include methods of centrifuging a sample in the rotors of the invention. For instance, the methods can include, e.g., providing a rotor comprising a plurality of clusters of sample receiving elements, loading at least one sample into at least one of the plurality of clusters, and rotating the rotor (thereby centrifuging the sample). The rotor can include any of the features noted above with respect to rotors comprising clusters.

Typically, the sample is contained within a vessel such as a centrifuge tube, which is loaded into the rotor, thereby loading the sample into the rotor, though any of the configurations noted above are applicable. Generally, the methods include inserting a group of sample processing components into at least one selected cluster. The group of sample processing components is typically coupled to a transport that inserts the group into a selected cluster. The group of sample processing components can be simultaneously (or serially, though this can reduce throughput) inserted into the selected cluster. The group of sample processing components typically performs a plurality of sample processing functions on materials contained within the selected cluster. The group of sample processing components are arranged so that when the group is inserted into the cluster, at least one sample processing component is inserted into each sample receiving element within the cluster. Any of the above arrangements of sample processing components or clusters can be used in this method. Further, the method optionally comprises positioning the cavities relative to the sample processing components using a reference index.

Optionally, the method includes performing at least 2 different sample processing operations simultaneously with the group of sample processing components.

The method optionally includes further steps, e.g., related to sample processing, re-use of the rotor, insertion or removal of vessels into the rotor (e.g., robotically) and the like. For example, the method can include removing the sample processing components, rotating the rotor, and re-inserting the set of sample processing components, where the sample processing components, after re-insertion, perform at least one operation (e.g., aspirating supernatant, delivering fluid to the sample receiving elements, sonicating a sample component in the sample receiving element, removing material from the sample receiving elements, dispensing material into the sample receiving elements, vibrating the sample, sonicating the sample, and/or measuring a property of the sample).

In one typical embodiment, The method includes removing liquid from the sample receiving elements, and depositing the liquid into a purification component such as a specimen collector (or any of the other purification components noted herein).

As noted, robotic methods of loading sample vessels into the rotor can be used. For example, a plurality of centrifuge vessels can be robotically attached to an arm of a robot. The arm can be moved adjacent to the rotor and robotically inserted into a selected cluster, e.g., at the same time. Similarly, the method can include robotically attaching a second plurality of centrifuge vessels to the arm of the robot and robotically inserting the second plurality of centrifuge vessels into a different selected cluster of the centrifuge rotor, e.g., at the same time. In one embodiment, the method includes robotically inserting a plurality of sample vessels into the clusters, robotically inserting a group of sample processing components into at least one selected cluster and performing a sample processing operation with the sample processing components. Similarly, the method optionally includes robotically removing a group of sample processing components from a first cluster, rotating the rotor until a second cluster is proximal to the sample processing components, re-inserting the sample processing components into a second cluster and again performing the same sample processing operation or a different sample processing operation on samples in the second cluster. Optionally, the method includes robotically inserting a cell pellet removal component which removes a cell pellet (e.g., a rod, spatula, or the like) from at least one of the sample vessels.

In one class of embodiments, the methods further include reintroducing supernatant removed from a centrifuge vessel into a corresponding centrifuge vessel. For example, this can also include centrifuging the removed supernatant once reintroduced into the corresponding centrifuge vessels to pellet a material of interest.

In one common embodiment of the systems, rotors and methods herein, the sample is a fermentation sample such as a culture of cells, a cell lysate or the like.

### BRIEF DESCRIPTION OF THE FIGURES

These and other features and advantages of the present invention will be appreciated from the following detailed description, along with the accompanying figures in which like reference numerals identify like elements throughout.

FIG. 1 is a perspective view showing a centrifuge rotor constructed according to the present invention and a group of sample vessels inserted therein.

FIG. 2 is a plan view of the embodiment illustrated in FIG. 1.

FIG. 2A is a phantom view of the embodiment illustrated in FIG. 2.

FIG. 3 is a plan view of an alternative embodiment centrifuge rotor constructed according to the present invention.

FIG. 4 is a side elevation view of a rotor cavity constructed according to the present invention.

FIG. 5 is a perspective view of a section of a rotor constructed according to the present invention and a schematic block diagram of associated components of the present invention.

FIG. 6 is a perspective view of the fraction collector depicted schematically in FIG. 5.

FIG. 7 is a perspective view of some of the components depicted schematically in FIG. 5.

FIG. 8 is an elevation view of one embodiment of an automated centrifuge of the present invention.

FIG. 9 illustrates the rotor and rotor cover illustrated in FIG. 7 and also illustrates the rotor control box of the present invention.

FIG. 10 is a side elevation view of a rotor constructed according to the present invention and a schematic block diagram of associated components of the present invention.

FIG. 11 illustrates one image projected on an operator interface illustrated in FIG. 8.

FIG. 12 is a perspective view of an alternative embodiment of the automated centrifuge of the present invention.

FIG. 13 is a perspective view of a section of a rotor employed in the centrifuge illustrated in FIG. 12.

FIG. 14 is a plan view of the rotor illustrated in FIG. 13.

FIG. 15 is a perspective view of a transport and waste trough illustrated in FIG. 12.

FIG. 16 is a perspective view of the waste trough illustrated in FIG. 15.

FIG. 17 is a perspective view of a sample/ fraction collector illustrated in FIG. 12.

FIG. 18 is a perspective view of an alternate sample/ fraction collector illustrated in FIG. 12.

FIG. 19 is a perspective view of an arrangement of tips which operate in the sample/ fraction collectors of FIG. 17 and FIG. 18.

Some or all of the Figures are schematic representations for purposes of illustration and do not necessarily depict actual relative sizes or locations of the elements shown.

### DETAILED DESCRIPTION OF THE INVENTION

Previously available centrifuge systems are generally simply “stand alone” centrifuges that are difficult to incorporate into high throughput sample processing systems, because they must be manually loaded and unloaded. This is time consuming, and therefore expensive. Indeed, loading and unloading centrifuge rotors can even be dangerous, due to the weight of the rotors that are often used and the awkwardness of lifting the rotor down onto a rotor spindle, as well as due to the possible presence of hazardous materials in sample tubes which are loaded into the rotor.

While some systems have been proposed for automated loading of centrifuge rotors (e.g., “Automated System Including Automatic Centrifuge Device,” U.S. Pat. No. 6,060,022 to Pang et al.) these systems have generally only proposed using simple robotics for the loading and unloading of sample containers, one a time, to and from the rotor. Furthermore, no attempt has been made in these systems to integrate sample processing and centrifugation.

The present invention takes a very different approach to the integration of centrifuge and sample processing elements. In particular, the systems of the invention are typically configured to provide sample processing while sample containers are in physically located in the rotor. This is accomplished by providing transport robotics coupled to sample processing components that are designed to be inserted into the sample containers. These sample processing components can include essentially any components that processes a sample and that can be configured to be inserted into a sample container. These include, without limitation, fluid handling components (e.g., dispensing and/or aspirating tubes), sample resuspension components (e.g., mixing or vibrating apparatus such as mixer elements or sonication rods), heater rods, refrigeration rods, heat sinks, detection elements (e.g., pH detectors, fiber or tube optics, temperature probes, conductivity probes), electrical probes, and many others that will be apparent to one of skill. Moreover, the transport robotics can be coupled to the sample processing components to provide for the simultaneous insertion of multiple sample processing components into one or multiple sample containers. The elimination of the need to load and unload samples to sample processing stations substantially increases throughput of the system, as does the ability to multiplex the sample processing components.

An additional aspect of the invention is that sample vessel transport robotics can be provided such that multiple samples can be loaded into a rotor simultaneously. This speeds the loading and unloading of samples into rotors and increases throughput of the overall system.

Rotors of the invention are optionally provided which facilitate insertion of sample processing components into the rotors. For example, rotors of the invention have sample receiving elements (e.g., cavities, depressions, holes, apertures, buckets, or the like, suitable for receiving a sample vessel such as a test tube), optionally arranged in clusters of elements.

Clusters of sample receiving elements are characterized in that they have one of at least two characteristics. First, the clusters typically display a distinct spatial grouping of the sample receiving elements. That is, when viewing the rotor, the sample receiving elements are arranged in spatially distinct groupings. Second, the clusters typically have sample receiving elements having substantially the same longitudinal axes. In most cases, the longitudinal axes of the clusters is not perfectly vertical, e.g., at least 1° off of vertical, typically about 5° or more off of vertical. In general, when referring to numeric ranges such as “about 5”, it will be appreciated that an equivalent range may be substituted.

For example, where the rotor is a fixed-angle rotor, sample receiving elements such as rotor cavities can be clustered in sets of non-vertical cavities, where each member of the cluster has substantially the same longitudinal axis. This facilitates insertion of sample processing components into the cavities, by permitting multiple sample processing components to be arranged along a single longitudinal axis as well, permitting simultaneous insertion of the sample processing components into the cluster. This increases the ability to multiplex simultaneous sample processing in the rotor, increasing the throughput of the system. Similarly, the clustered nature of the sample receiving elements permits a centrifuge vessel loading robot to arrange the vessel insertion components of the robot along the same axis, facilitating simultaneous loading of vessels into the clusters and, again, increasing the overall throughput of the system.

The system can include any of a variety of additional traditional or non-traditional sample storage or processing components as well. For example, the system can include refrigeration components (indeed, any part or all of the system can be refrigerated to prevent sample degradation), sample purification apparatus (e.g., sample/ fraction collectors, sample purification columns, etc.), sample analysis apparatus (sample electrophoresis apparatus, spectrophotometers, mass spectrometers, etc.), station robotics that move samples or sample vessels between stations, sample vessel cleaners that clean sample vessels for re-use in the system, and tracking/inventory systems that track the status and/ or location of samples in the systems.

Accordingly, the present invention alleviates, to a great extent, deficiencies of known centrifugation processes, e.g., by providing an automated centrifuge system that can incorporate any of several processing steps, e.g., within a single processing station or set of related stations. Typically, the automated centrifuge system includes at least one centrifuge rotor defining a sample receiving element such as a cavity. One or more movable sample vessels are structured to be insertable into the cavity. A transport is configured to position and insert one or more movable sample vessels into the cavity. Once the sample vessels are inserted into the cavity, the system performs a sample treatment (e.g., fluid movement) function such as aspiration, dispensing, sonication or the like.

One embodiment of the automated centrifuge system employs a centrifuge rotor defining a cluster of sample receiving elements such as rotor apertures (also referred to as “holes”) located in the rotor. Each aperture has a longitudinal axis and the longitudinal axes of the cluster of rotor holes preferably are substantially parallel, although any arrangement of rotor holes may be used that can suitably receive and position sample vessels. A group of movable sample vessels (e.g., centrifuge tubes) are positioned by a transport so that the movable sample vessels are capable of being inserted into the cluster of rotor apertures.

The automated centrifuge system of the present invention affords several advantages. For example, sample receiving elements are optionally grouped in sets with each sample receiving element in the set being substantially parallel to all the other sample receiving elements in the set. Such an arrangement permits the simultaneous insertion of a group of tubes for further processing steps, such as automated aspiration or dispensing of fluids without removing the sample vessels to a separate processing station. A sonication device can also be inserted (simultaneously or separately) with the aspiration/dispensing tube. Advantageously, suspended materials can be centrifuged, aspirated, sonicated, and centrifuged again without the removal of the sample vessels from the centrifuge and, optionally, without human intervention. The present invention introduces numerous advantages over current technology, in that multiple-step procedures involving centrifugation that formerly required substantial human involvement and physical transfer of sample vessels to separate processing stations are now incorporated into an apparatus that performs multiple step processes at a single processing station.

Moreover, the automated centrifuge system of the present invention increases the reproducibility of experimental results, thereby decreasing the possibility of operator variation or error. Accordingly, other advantages of the present invention include reducing operator error and increasing the consistency and reliability of experimental results.

In one aspect, the present invention provides an automated centrifuge system. The system optionally includes: (a) a group of sample processing elements such as movable tubes, each structured to transport a liquid; (b) a cluster sample receiving elements such as rotor holes located in a rotor, arranged to receive the group of sample processing elements; and (c) a transport holding the sample processing elements and constructed to substantially simultaneously move the group of sample processing elements into the cluster.

Thus, in one embodiment, the automated centrifuge system includes: (a) a rotor; (b) a cavity located in the rotor; (c) a tube structured to be insertable into the cavity; (d) a transport coupled to the tube; and (e) a controller communicating with the transport, the controller directing the transport to insert the tube into the cavity.

In an alternate embodiment, the automated centrifuge system includes: (a) a cluster of holes located in a rotor; (b) a group of tubes configured to be received into the cluster of holes; (c) a transport operably coupled to the group of tubes; and (d) a controller that directs the transport to insert the group of tubes into the cluster of holes. The system may also include: (1) a second (or additional) rotor, the second rotor including a cluster of holes; and (2) a movable platform coupled to the transport; wherein the movable platform moves the transport to selectively position the group of tubes for insertion into the cluster of holes in the rotor and into the cluster of holes in the second rotor.

In another aspect, the automated centrifuge includes: (a) means for placing a plurality of vessels in a plurality of centrifuge rotor cavities; (b) means for substantially isolating a majority of a sample component located in each vessel by centrifugation; (c) means for re-suspending the component in a first group of vessels; and (d) means for substantially simultaneously dispensing a substance into a second group of vessels.

In still another aspect, the invention provides a method of automated centrifugation. The method includes the steps of: (a) placing a vessel in a centrifuge rotor cavity; (b) substantially isolating a majority of a component located in the vessel by centrifugation; and (c) re-suspending a majority of the component while the vessel is located in the centrifuge rotor cavity. In another aspect, the method of automated centrifugation includes the steps of: (a) arranging a cluster of cavities on a centrifuge rotor, each cavity configured to receive a sample; (b) inserting a set of elongated tubes into the cluster of cavities, each tube being inserted into a corresponding cavity for depositing a liquid in each cavity; and (c) centrifuging the liquid and the sample.

The inventions also features a centrifuge rotor. The rotor includes a cluster of sample receiving elements located in the centrifuge rotor, each including a longitudinal axis. The longitudinal axes of the sample receiving elements in the cluster are substantially parallel.

Other aspects of the invention feature: (a) automated loading and unloading of the centrifuge rotor using a robot; (b) automated manipulation of samples in vessels in a centrifuge rotor using a robot; (c) an automated method for moving samples into cavities of a centrifuge rotor using a robot; (d) an automated method for manipulating samples in vessels in a centrifuge rotor using a robot; (e) controller logic (e.g., the logic for controlling the various automated operations of the system, e.g., system software comprising instructions and/or code embodied in a computer readable medium), as well as the sample tracking logic; and (f) an overall automated method.

The number of various elements or steps of the invention may be modified. For example, in preferred embodiments, the rotor body may comprise 1, 2, 3, 4, 5, 6, 7, 8 or any whole number of clusters and each cluster may have 1, 2, 3, 4, 5, 6, 7, 8, 9, 10, 11, 12, 13, 14, 15, 16 or any whole number of cavities. The number of cavities or clusters can thus be, for example, any integer between 1 and 100, e.g., between 1 and 50 or, e.g., between 1 and 25. In addition, the robot is capable of positioning at least 2 centrifuge vessels, for example, into cavities in a same cluster of the centrifuge rotor at the same time. Again, any number of centrifuge vessels can be positioned by the robot in such a manner, a number that corresponds to the number of cavities. Finally, a plurality of sample processing elements such as sample probes are capable of performing a function on at least 3 different samples, for example, at the same time. The sample processing elements, however, may be able to perform a function on at least any number of different samples at the same time. The number of different samples is any integer between 1 and 100, e.g., between 1 and 50, or, e.g., between 1 and 25.

The systems, devices and methods of the present invention optionally include means or steps for recognizing specific tubes or vessels, or groups of tubes or vessels, as they are placed into the centrifuge and/or mechanisms or steps for indexing or tracking one or more tubes or vessels as they are transferred from the centrifuge to another system, device or method, for example a fermentor. For example, the system, device or method may incorporate barcodes or colors to achieve the above, either manually or robotically.

Further details on rotors, sample processing and sample processing components and other elements of the systems are found below.

Rotors

The above provides a general discussion of the types of rotors that are suitably used in the systems of the invention and many specific examples are set forth in the figures below. Other than the clustered nature of preferred rotors, traditional methods of rotor manufacture and materials used for rotors can be used in the present invention. Rotors are manufactured from a wide variety of metals, composites, ceramics and polymers, depending on the g-forces to be experienced by the rotor, the properties of the samples to be centrifuged, and compatibility with existing centrifuges. Fixed angle rotors are particularly suitably arranged to include clusters of sample receiving elements, though swinging bucket rotor configurations can also be used (in a swinging bucket configuration, the axes of the sample receiving elements (e.g., the buckets) go to vertical when the rotor is not spinning. The general considerations for rotor design are well established and are considered to be well within the capabilities of one skilled in the art of high speed rotating machinery.

In addition to cluster rotors, traditional rotors can be used in the present invention, e.g., by arranging the sample processing components to mate with the longitudinal angles of the relevant available rotors at rest, or, e.g., by inserting sample processing components one at a time into the relevant sample receiving elements. Literally thousands of rotors are commercially available and can be used in the systems of the invention.

Sample Processing Components

The sample processing components of the invention are arranged for insertion into sample vessels while they are located in a rotor. The discussion above provides a general overview of the configuration of the sample vessels and many specific example configurations are set forth below. At least three general types of sample processing components can be used in the systems of the invention.

First, the sample processing components can add or remove fluid or other materials to sample vessels in the rotor. Common configurations include tubes which dispense fluid into the sample vessels and tubes which remove fluid from sample vessels (the same tube can serve both functions, or different tubes can serve these functions). The tubes can be made of any material that is substantially inert with respect to the fluids and/ or the samples. Common materials include stainless metals (e.g., stainless steel), plastics, polymers, ceramics, coated materials (e.g., metal, ceramic or plastic coated with a non-stick surface such as TEFLON™) and/or the like.

Second, the sample processing components can mix or suspend sample components in the sample vessels. Common examples of such components include vibrating rods (e.g., sonication rods), rotary mixers, and the like.

Third, the sample processing components can analyze or treat the materials in the sample vessels. Common analyzer components include pH meters, thermometers, current meters, ion meters, electrodes, magnetic field detection components, radiation detection elements, optical elements (e.g., fiber optics, tube optics, lenses, photodiodes, photoemitters, etc.), spectrophotometer elements, heater or refrigeration elements (e.g., resistively heated wires, heat sinks, Peltier heaters or coolers, or the like), and many others. These elements can perform simple operations such as analyte detection (e.g., via pH detection, detection of an emitted signal such as a fluorescent emission, or the like), or can perform complex experimental operations such as controlled heating and cooling for thermocyclic reactions, cell lysis operations (e.g., via delivery of detergent or heat), or the like.

Any other available sample processing component that can be configured to be inserted into a sample receiving element can be used in the systems of the invention.

Robotics

Any of a variety of traditional robotics can be employed to move samples or sample vessels between work stations and to move sample processing components proximal to or inserted into sample receiving elements. Such robotics can include robotic armatures, grasping components, conveyor systems (e.g., conveyor belts) or the like. Typically, robotic components are coupled to a control system that directs sample/ sample vessel movement between stations, and/or sample/ vessel tracking within the system, and/or sample processing component movement to the rotor, rotor positioning, and/ or the like.

Many such robotic components are commercially available. For example, a variety of automated systems are available from the Zymark Corporation (Zymark Center, Hopkinton, Mass.), which utilize various Zymate systems, which can include, e.g., robotics and fluid handling modules. Similarly, the common ORCA® robot, which is used in a variety of laboratory systems, e.g., for microtiter tray manipulation, is also commercially available, e.g., from Beckman Coulter, Inc. (Fullerton, Calif.). Another example set of robotics are available from Staübli which provide good freedom of movement for the arms of the robot armatures.

In addition, the auto industry provides sophisticated robotics that can be adapted to the systems herein. General introductions and resources related to robotics can be found on the internet at (www.) robotics.cs.umass.edu/robotics.html; ri.cmu.edu/; robotics.stanford.edu/ and many other sites.

Sample Processing

Samples can be any of a variety of biological or non-biological components. For example, where biological samples are at issue, any of a variety of proteins, cells, cell fractions, nucleic acids, or the like can be the desirable component of the sample. Thus, the systems of the invention can include biological production components and the methods of the invention can include delivery of biological components to sample receiving elements and/ or processing of components from such sample receiving elements.

An introduction to biological sample preparation, component purification (e.g., nucleic acid and/or protein purification) and many other sample preparation procedures can be found in many available standard texts, including Berger and Kimmel, Guide to Molecular Cloning Techniques, Methods in Enzymology volume 152 Academic Press, Inc., San Diego, Calif. (Berger); Sambrook et al., Molecular Cloning—A Laboratory Manual (3rd Ed.), Vol. 1-3, Cold Spring Harbor Laboratory, Cold Spring Harbor, N.Y., 2001 (“Sambrook”) Current Protocols in Molecular Biology, F. M. Ausubel et al., eds., Current Protocols, a joint venture between Greene Publishing Associates, Inc. and John Wiley & Sons, Inc., (supplemented through 1999) (“Ausubel”)); Freshney (1994) Culture of Animal Cells, a Manual of Basic Technique, third edition, Wiley- Liss, New York and the references cited therein, Payne et al. (1992) Plant Cell and Tissue Culture in Liquid Systems John Wiley & Sons, Inc. New York, N.Y.; Gamborg and Phillips (eds) (1995) Plant Cell, Tissue and Organ Culture; Fundamental Methods Springer Lab Manual, Springer-Verlag (Berlin Heidelberg New York) and Atlas and Parks (eds) The Handbook of Microbiological Media (1993) CRC Press, Boca Raton, Fla.; Protein Purification, Springer-Verlag, N.Y. (1982); Deutscher, Methods in Enzymology Vol. 182: Guide to Protein Purification, Academic Press, Inc. N.Y. (1990); Sandana (1997) Bioseparation of Proteins, Academic Press, Inc.; Bollag et al. (1996) Protein Methods, 2^{nd} Edition Wiley-Liss, NY; Walker (1996) The Protein Protocols Handbook Humana Press, NJ, Harris and Angal (1990) Protein Purification Applications: A Practical Approach IRL Press at Oxford, Oxford, England; Harris and Angal Protein Purification Methods: A Practical Approach IRL Press at Oxford, Oxford, England; Scopes (1993) Protein Purification: Principles and Practice 3^{rd} Edition Springer Verlag, NY; Janson and Ryden (1998) Protein Purification: Principles, High Resolution Methods and Applications, Second Edition Wiley-VCH, NY; and Walker (1998) Protein Protocols on CD-ROM Humana Press, NJ; and the references cited therein.

In addition to sample processing components which are inserted into sample receiving elements, any of a variety of sample production, treatment, processing and purification systems can be incorporated into the automated systems of the invention. These can include, e.g., cell fermentation apparatus which produce cells to be delivered to a sample receiving region, sample/fraction collectors which process materials from the sample receiving region, refrigerated modules that store samples and sample materials, analysis stations that perform sample or sample component analysis (e.g., mass spectroscopy equipment, gel electrophoresis apparatus, capillary electrophoresis equipment, photodiodes or photo-emitter arrays, microscope stations, cell sorters, flow cytometers, FACS equipment, DNA chips, nucleic acid or protein blotting stations, 2-d electrophoresis stations, etc.) and the like. Many such components are set forth in the references above and are commercially available. One example cell fermentation apparatus that can be used in conjunction with the centrifuge elements herein is set forth in “Multi-Sample Fermentor and Method of Using Same” by Downs et al. Attorney Docket Number 36-001910PC, concurrently filed.

System Logic

As noted herein, any component of the system can be coupled to an appropriately programmed processor or computer which functions to instruct the operation of these components in accordance with preprogrammed or user input instructions, receive data and information from these components, and/or interpret, manipulate and report this information to the user. As such, the computer or processor is typically appropriately coupled to one or more components (e.g., including an analog to digital or digital to analog converter as needed).

The computer typically includes appropriate software for receiving user instructions, either in the form of user input into a set parameter fields, e.g., in a GUI, or in the form of preprogrammed instructions, e.g., preprogrammed for a variety of different specific operations. The software then converts these instructions to appropriate language for instructing the operation of the system carry out the desired operation. The computer or controller then receives data from the one or more sensors/detectors included within the system, and interprets the data, either providing it in a user understood format, or using the data to initiate e.g., controller instructions, in accordance with the programming, e.g., such as in monitoring and control of flow rates, temperatures, applied motor current or voltages, and/or the like.

In the present invention, the computer or controller typically includes software for the monitoring of materials in the system. These can include spreadsheet programs, database programs, inventory programs or the like. Additionally, the software is optionally used to control injection or withdrawal of material from the sample receiving elements, mixing or sonication of samples, fraction collector functions or the like.

### EXAMPLE EMBODIMENTS

The present invention provides automated systems comprising centrifuge elements, new centrifuge rotors that can be used in the system and new robotic systems that interface with the centrifuge rotors. In the following paragraphs, the present invention is described in detail by way of example with reference to the figures. Throughout this description, the preferred embodiment and examples shown should not be considered as limiting the scope of the present invention. Many equivalent embodiments are apparent to one of skill.

Described below are: (a) an automated centrifuge system, (b) the functions of the automated centrifuge, and (c) an alternative automated centrifuge system.

I. Automated Centrifuge System

Referring to FIG. 1, example automated centrifuge system 10 is shown. Generally, automated centrifuge system 10 comprises rotor 20 having cluster 35 of sample receiving elements (in this case rotor cavities) 25 arranged to cooperate with group of sample processing elements (in this case tubes for fluid delivery or removal) 61. Each cavity in the cluster holds a sample, while each tube is used to aspirate or dispense a fluid from its associated cavity. Group of tubes 61 are moved by transport 135 so that each tube in the group is insertable into associated cavity 25 in cluster 35. Accordingly, the cooperative and complementary arrangement of the cluster and group of tubes enable the efficient automated processing of samples (or any other materials) held in each cavity.

For example, rotor 20 can be rotated until cluster 35 is positioned in a cooperative manner with group of tubes 61. Rotor 20 then can be held in place when each tube 60 is positioned so that it is insertable into corresponding cavity 25. When positioned, transport 135 is moved to cause tubes 60 to be inserted into cavities 25. Once inserted, the tubes provide a sample treatment function, e.g., a fluid movement function, such as dispensing a buffer or aspirating a fluid product into or from one of the tubes. When the sample treatment function is complete, the transport moves to cause the tubes to be removed from the cavities. With tubes 60 removed, rotor 20 is optionally freed and the samples centrifuged.

Several clusters 35 preferably are arranged radially on rotor 20. As the rotor is rotated, different sets of cavities 25 are positioned to receive group of tubes 61. In such a manner, each set of cavities 25 in rotor 20 is acted upon by the same group of tubes 61, in a sequential manner. With automated centrifuge system 10, rotor 20 can be loaded with many samples, and a multiple step process can be performed on each sample (or on selected samples) without any human intervention. More specifically, several centrifugation, dispensing, and aspirating steps can be performed with controlled accuracy and repeatability using the automated system. Accordingly, a process, such as a protein isolation process, can be performed more efficiently, more quickly, and more reliably than by using a conventional system.

Referring again to FIG. 1, rotor 20 in centrifuge system 10 contains a plurality of cavities 25 arranged in cluster 35. Each cavity 25 has a longitudinal axis, and in one preferred embodiment, the longitudinal axes of each cavity 25 in each cluster 35 are substantially parallel to each other. Tubes 60 that are coupled to a robotic actuator or transport 135, which inserts the tubes into corresponding cavities. In the embodiment illustrated, tubes 60 are arranged in a set and can be substantially simultaneously inserted into cavities 25, because the longitudinal axes of the cavities are substantially parallel to the longitudinal axes of tubes 60. In this manner, a plurality of tubes 60 can be inserted into a plurality of cavities 25.

The precise nature of the transport robotics that moves either the sample processing components or sample vessels varies according to the application and, e.g., the nature of the tubes used in the system. For example, sample processing components or sample vessels can be gripped externally by the relevant robotics, e.g., where the sample vessels comprise a mating feature that mates with the transport robotics. This can be as simple as an outside dimension of the relevant sample processing component or sample vessel, or can be more sophisticated, e.g., a lip on the sample vessels (e.g., near or at the top of the vessels), or a fitting on the sample processing component that is grasped by the robotics. In another embodiment, the relevant robotics are designed to grip the inside, e.g., of a transport vessel, e.g., via simple friction or by contacting a specialized mating feature that fits with the transport vessel.

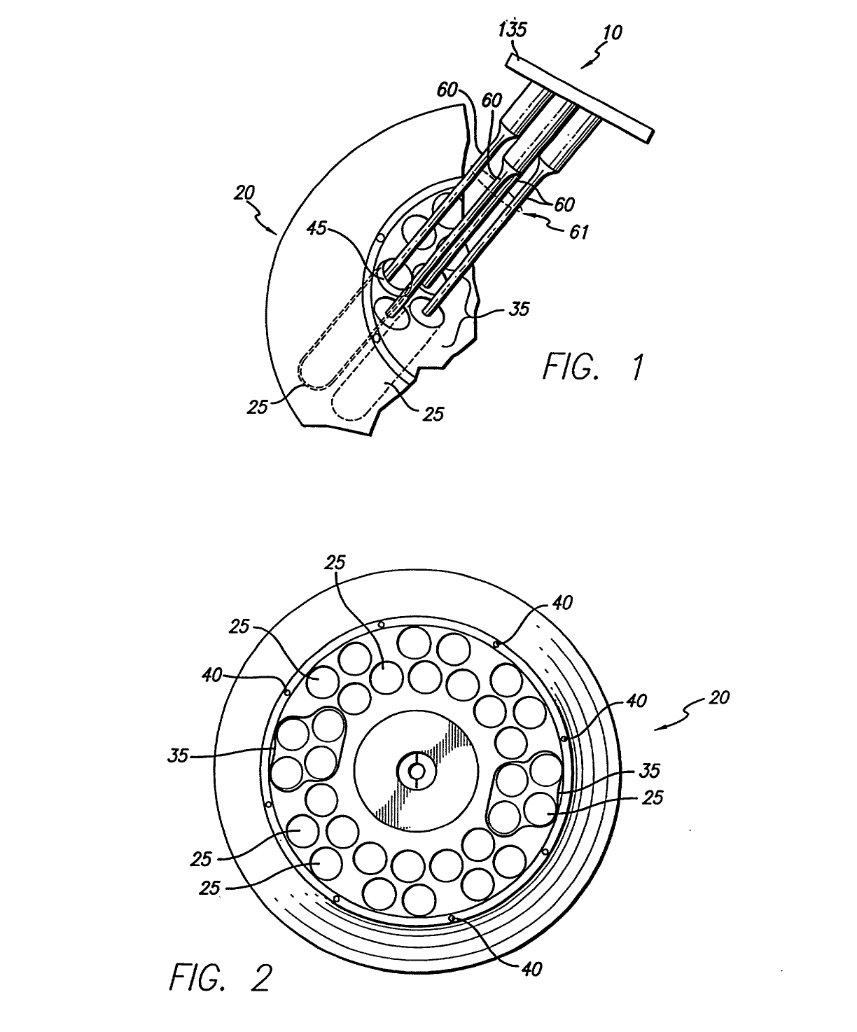

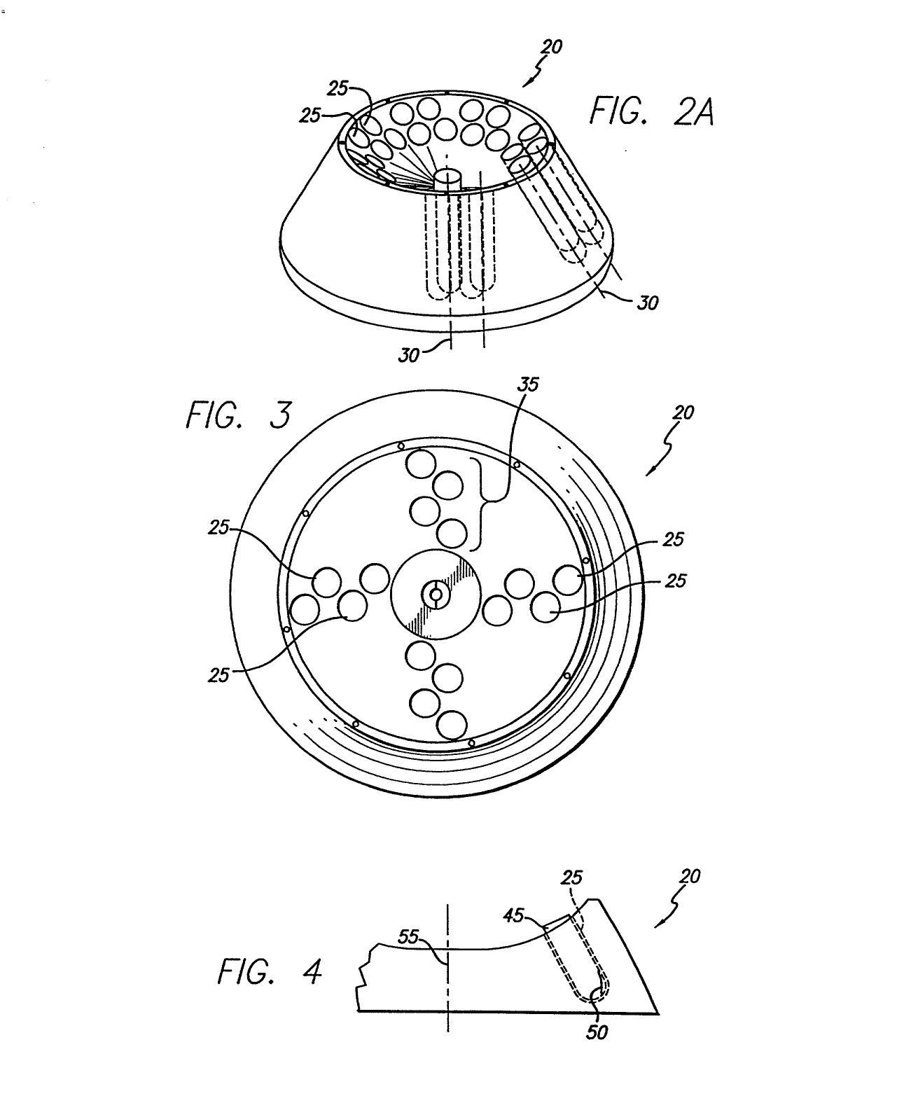

Referring to FIGS. 2 and 2A, another aspect of the present invention is illustrated. Centrifuge rotor 20, for use in a centrifuge system, contains a plurality of cavities 25 (e.g., rotor holes). Although, in a preferred embodiment, cavity 25 (a sample processing component) is simply a rotor hole, the sample processing component can take other forms. For example, the component can be a well in a sample plate, a bucket in a bucket rotor, or the like.

In the preferred embodiment, each cavity 25 has a longitudinal axis (e.g., longitudinal axis 30) that is configured to receive a vessel 45 (shown in FIG. 1). In a preferred embodiment, vessel 45 holds a biological sample (a sample comprising or derived from a biological material, such as a cell, cell lysate, solution comprising a protein, solution comprising a nucleic acid, or the like). However, in an alternate embodiment, the biological sample (or any other sample) is optionally placed directly into the sample receiving element (e.g., cavity 25) to satisfy application specific needs.

As shown in FIGS. 2 and 2A, sample receiving elements are arranged in clusters, e.g., clusters 35. In the embodiment illustrated, cluster 35 comprises four cavities 25. In the illustrated embodiment, the longitudinal axis (e.g., axis 30) of each cavity in each cluster is substantially parallel.

As illustrated in FIG. 3, the clusters can be arranged substantially radially in centrifuge rotor 20. In contrast to conventional centrifuge rotors that have individual rotor holes with non-parallel longitudinal axes, rotor 20 has clusters 35 arranged so that the cavities are substantially parallel in a cluster while the clusters are radially arranged on the rotor. The number of sample receiving elements in each cluster can vary depending upon the size of the rotor, the size of the sample receiving elements, or other relevant factors such as the material of the rotor, the rotational operating speed of the rotor and the like. The number of clusters in a rotor can also vary. For example, in a preferred embodiment, the centrifuge rotor has thirty-two cavities arranged in eight clusters. In another embodiment, the rotor has ninety-six cavities arranged in twenty-four clusters.

As illustrated in FIGS. 2, 2A and 3, the shape of rotor 20 is substantially triangular with a flat base and an annular upper surface. Rotor 20 can be made from aluminum, steel, polymers (e.g., plastics) or other suitable materials. One embodiment is manufactured from an aluminum alloy and coated with an epoxy-Teflon mixture that resists reaction with laboratory chemicals. However, the material, size and general shape of the rotor can be adjusted for application specific needs.

Each cavity 25 of centrifuge rotor 20 is sized to accommodate sample vessel 45 (e.g., a test tube). Other vessel configurations can be substituted. For example, the vessel can be a well in a plate, with the plate having a plurality of sample wells. In such a manner, the plate is optionally received in the rotor.

In any case, the vessels are capable of undergoing multiple process steps, before or after the isolation process. Each of the vessels optionally has a surface that is designed to interface with a transporter which transfers the vessel to another processing station. For example, the vessels optionally comprise lips (e.g., on the outer surfaces) which can easily be gripped by a robotic apparatus. Alternately, the transporter can have generic transport mechanisms, e.g., which insert into a vessel and expand, gripping the vessels from the inside of the vessel. The transport can, thus, rely on simple frictional forces to grip the inside (or, similarly the outside) of a vessel such as a tube, or alternately, can grip a structure such as a lip, detent, groove, indentation or other structure on the outside (or, similarly, the inside) of the tube.

Vessels such as vessels 45 are constructed such that post- and pre-isolation steps may be conducted directly on the material in the vessel. The compatibility of the vessel with other processing steps performed prior to or after the isolation process eliminates increased production costs incurred from transferring material from one vessel a second or third vessel, and then cleaning and sterilizing the used vessels. Further, eliminating one or more transfer steps increases the efficiency of the overall process, because of the decreased production time in not having to perform an extra transfer step and the increased yield from not losing any material in a transfer step.

In the illustrated embodiment, a common use for a centrifuge is to concentrate or purify materials, e.g., that are in suspension or dissolved in fluids. The fluid is placed in vessel 45 with the vessel then being placed in cavity 25. Rotor 20 is then spun by rotor motor 27 or other suitable device to create a centrifugal force on the fluid inside in vessel 45. The centrifuge is optionally refrigerated, e.g., to prevent sample degradation or to keep a cell culture from growing.

Rotor motor 27 optionally accurately positions and indexes the rotor. This motor can be a single motor or can be more than one motor. That is, the motor can provide both forms of rotor control (rotation for centrifugation or for rotation to align sample receiving elements and sample processing elements).

The centrifugal force acts on the fluid and objects suspended in the fluid, separating them by density. For example, suspended particles denser than the suspending liquid tend to migrate towards the side of vessel 45, e.g., as illustrated in FIG. 4. When the centrifugation process is complete, pellet 50 of denser material forms on the side or bottom of vessel 45 (depending on the angle of the vessels relative to the centripetal force exerted on them in the rotor). Illustrated in FIGS. 2, 2A and 4, cavities 25 are angled relative to rotor rotational axis 55. Vessel 45, located in cavity 25 is thereby also angled, which positions pellet 55 near the bottom of vessel 45. In a preferred embodiment, this angle is about 32 degrees, but other angles can be employed to locate pellet 50 in a different location in vessel 45.

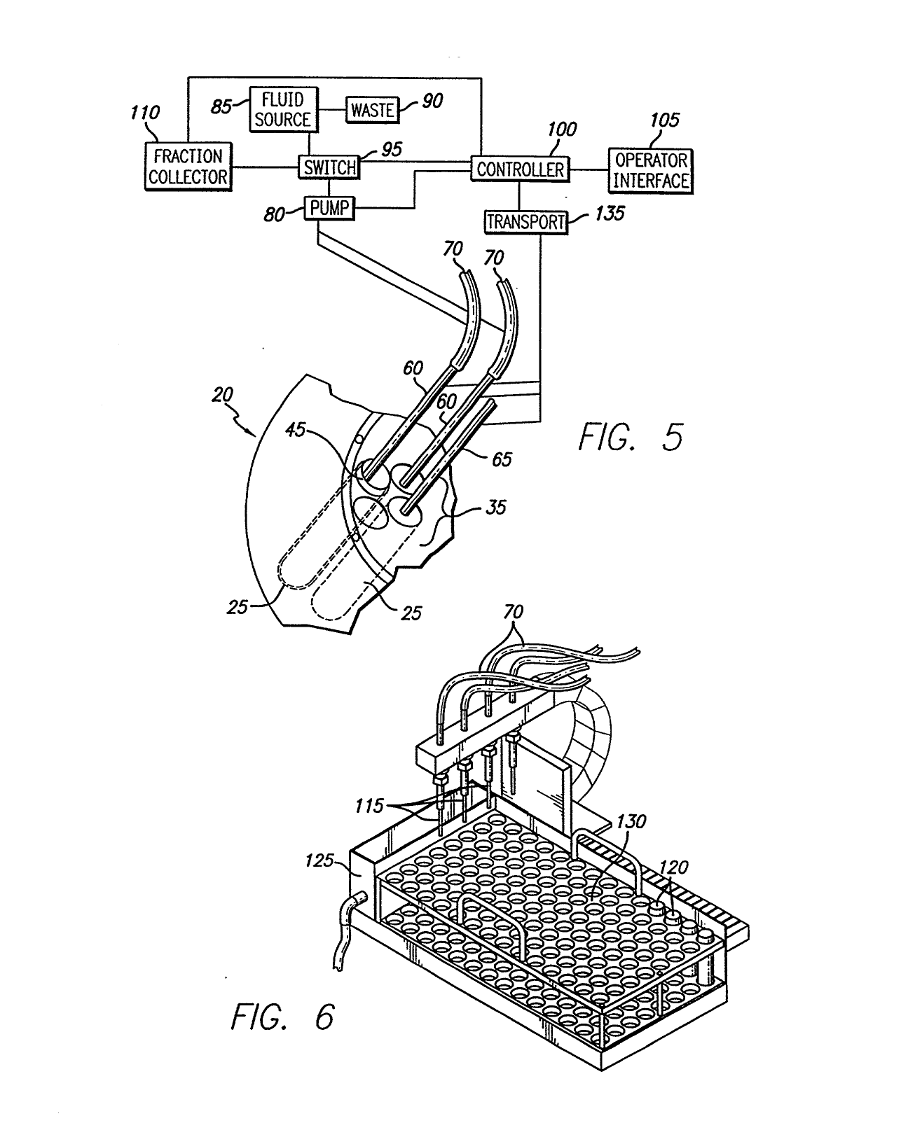

Referring to FIG. 5, cluster 35 is illustrated with tube 60 inserted in cavity containing vessel 45. Tube 60 is connected to hose 70 that communicates with pump 80. Fluid source 85, fraction collector 110 and waste deposit 90 communicate with pump 80 through switch 95. Tube 60 is moved into and out of cavity 25 by transport 135. Controller 100 also optionally directs pump 80 and switch 95.

Although depicted as a single element, controller 100 can be a control system having one or more controller elements. For example, the controller (or control system) can be a programmable logic controllers, a set of programmable logic controllers, a computer, a network of computers, or the like.

Also illustrated in FIG. 5 is second tube 60 and sonication rod 65. In one illustrated embodiment, the robotic actuator controls four tubes 60 and inserts them, e.g., substantially simultaneously, into cluster 35 (in this example including four cavities 25). Because the longitudinal axes of the four cavities are substantially parallel, the four tubes can be inserted substantially simultaneously into the cavities. In this manner, tubes 60 can simultaneously dispense fluid from fluid source 85 or aspirate fluid from vessel 45 and into waste dump 90 or into fraction collector 110. In another embodiment, sonication rod 65 is coupled with each tube 60 so that sonication can be performed during, before or after aspiration or dispensing of fluid by tube 60. In yet another embodiment, tube 60 is inserted in one cavity 25 while sonication rod 65 is inserted in a second adjacent cavity 25, and in this manner, different steps can be performed simultaneously within each cavity 25. Different combinations of tubes 60 and sonication rods 65 can be employed, with a myriad combination of aspiration/dispenselsonication procedures possible.

Tube 60 is connected by hose 70 to pump 80 which, in one embodiment is a peristaltic pump. Other types of pumps (e.g., pneumatic or pressure-based) can also be employed for pumping fluids through hoses 70. Hoses 70 preferably are made of nylon tubing, which resist reaction with laboratory chemicals, and the tubes are preferably made of stainless steel, or a coated material which resists reaction with laboratory chemicals. In a preferred embodiment, the tubes are made of 316 stainless steel, but the tubes and hoses can be made of other suitable materials. For example, in another preferred embodiment, other types of materials such as 304 stainless steel are used in place of 316 stainless steel, e.g., where the 304 stainless steel is coated with TEFLON™ or a similar non-stick coating. Similarly, sonication rod 65 is optionally made of titanium, but other suitable materials can be used for the sonication rod.

Fluid source 85 optionally comprises buffers, washes, cleansers and other fluids and substances useful for conducting one or more desired scientific tests. For example, a variety of buffers, such as Triton X-100, DB (deoxycholate buffer), and GB (guanidine buffer), all manufactured by Sigma-Aldrich Company of St. Louis, Mo., can be employed in the fluid source 85. In a preferred embodiment, up to six or more different fluids can be employed in the fluid source 85, but more or fewer fluids (as necessary to conduct a specific test) can be used in the fluid source 85.

Waste dump 90 is configured to accept waste fluids from the pump 80. In one embodiment, waste dump 90 comprises a hose that runs to a container located outside of the automated centrifuge. Alternatively, waste dump 90 can, be e.g., a trough located adjacent to fraction collector 110. Also, waste dump 90 can be located adjacent to rotor 20. Switch 95 comprises one or more switches that preferably comprise electrically driven solenoids, e.g., solenoid valves. In one embodiment, the wetted surfaces in switches 95 include TEFLON™, or are TEFLON™-coated (TEFLON is a registered trademark of E. I. du Pont de Nemours, a Delaware corporation), but other types of switches having other types of suitable coatings or base materials can also be employed.

Referring to FIGS. 5 and 10, controller 100 can be a specifically designed controller or a general purpose computing device such as a personal computer that includes or controls one or more programmable logic controllers. Other types of general purpose computing devices can similarly be used as controller 100. In a preferred embodiment, a personal computer using RS VIEW software, manufactured by Allen Bradley, provides operator interface 105, that directs controller 100. Controller 100 communicates with transport 135, pump 80, switch 95, fraction collector 110, and other devices on the automated centrifuge through wires or other suitable means.

Illustrated in FIGS. 5 and 6, fraction collector 110 is connected to switch 95 and to controller 100. Fraction collector 110 comprises hoses 70 connected to one or more tips 115 which dispense fluid obtained from one or more vessel 45 into specimen collectors 120 that are located in tray 130. Depending upon the fluid in hoses 70 and the instruction from controller 100, tips 115 can also dispense fluid into waste trough 125 located adjacent to tray 130. Specimen collectors 120 collect material that is obtained from the vessels by one or more tubes 60 after a separation procedure has been completed by centrifugation. Tips 115 can vary in number depending upon the number of tubes that obtain fluid from the vessels.

In one embodiment, four tips 115 correspond to four tubes 60 that are inserted into cluster 35 containing four vessels 45. The number of tips 115 can vary depending upon the number of tubes 60 and the number of corresponding cavities 25 in each cluster 35. The tips communicate with controller 110 and are movable so that they can dispense fluid into any number of specimen collectors 120, where the specimen collectors are, e.g., in a 96, 384, 1536 or other standard member sample format. In a preferred embodiment, tips 115 are mounted on a sliding actuator that is controlled by an electric motor. The tips can be moved by other means such as hydraulic, pneumatic or other suitable movement devices.

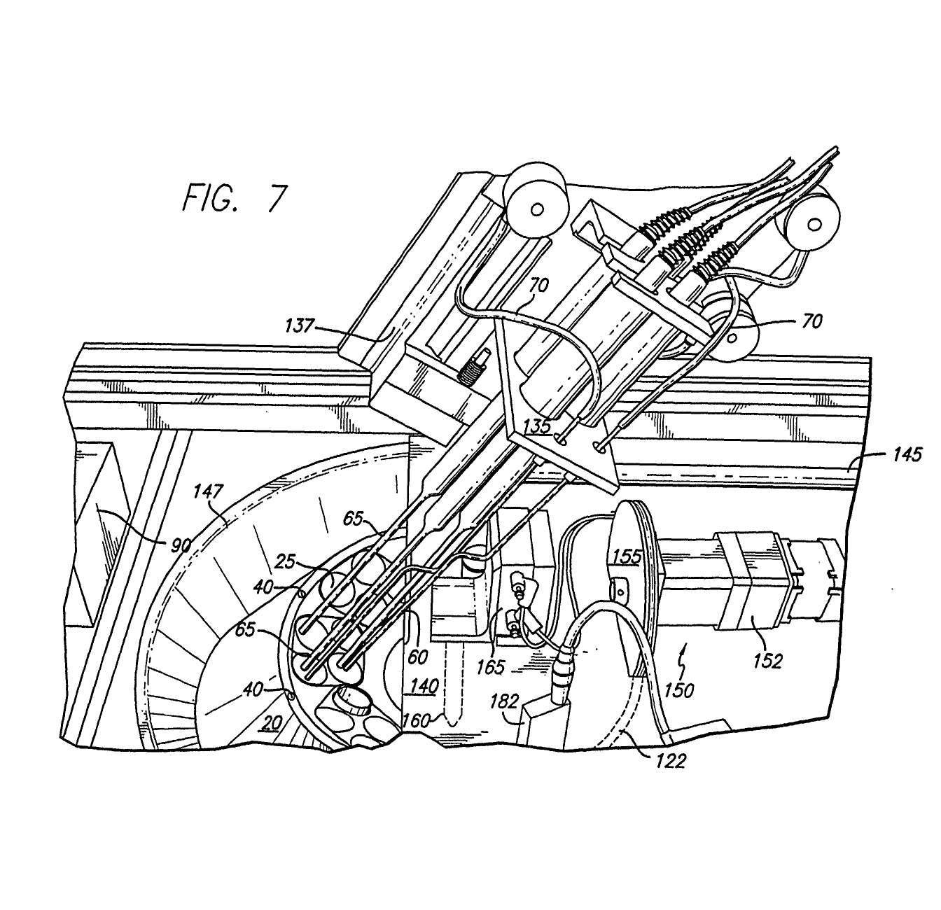

Referring to FIG. 7, one embodiment of the present invention is illustrated. In this embodiment, rotor 20 having cluster 35 containing four cavities 25 is configured to be substantially simultaneously inserted with a group of tubes 60 and rods 65 arranged in pairs so that one tube and one rod are inserted into each cavity 25. In this arrangement, each cavity 25 of cluster 35 can be simultaneously inserted with tube 60 and rod 65. Transport 135 holds the four tubes 60 and four rods 65, and as discussed above, the tubes are connected to hoses 70 and the rods comprise a sonication device employing, e.g., a 20 kilohertz transducer. The sonication device re-suspends particles that have been compressed by centrifugation. Other types of re-suspension devices can be employed, such as chemical re-suspenders, pipettors, etc.

Movable transport 135 is mounted on pneumatic slide 137 that is actuated by controller 100 to insert and remove tubes 60 from cavities 25. In addition to the movement into and out of the cavities, the transport can also be moved horizontally by an electric motor that communicates with the controller. In this manner, the transport can be moved away from rotor 20 to permit insertion of vessels 45 into the rotor and removal of the rotor from the centrifuge.

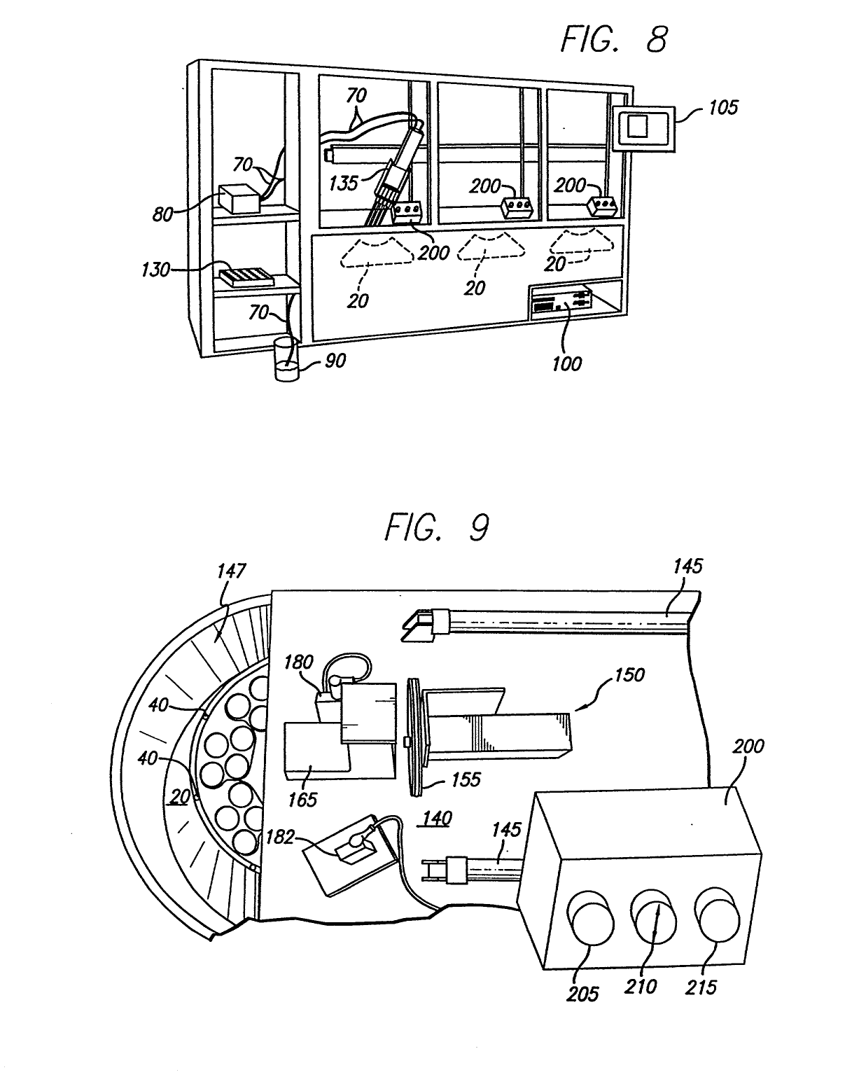

Also, as shown in FIG. 8, one embodiment of the present invention employs three rotors 20, and transport 135 can be moved into position over each rotor 20 by controller 100 directing the movement of the transport. The number of rotors incorporated into an automated centrifuge constructed according to the present invention can vary according to the needs of the laboratory, or research facility. Similarly, the system can be reconfigured so that the rotors move relative to tubes 60, rather than moving the tubes with transport 135. Also shown in FIG. 8, are operator interface 105, fluid pump 80, and rotor control boxes 200.

Another preferred embodiment employs multiple transports, such as transport 135. With multiple transports, each transport can be arranged to simultaneously (or sequentially, if desired) cooperate with different clusters 35. In such a manner, the same sample treatment function can be performed on more cavities 25 at the same time, enabling a more high throughput operation. Alternatively, each transport can control a group of tubes 61 to perform a single function, which minimizes the need for washing or cleaning the tubes between process steps. For example, one group of tubes is optionally used to dispense a buffer, another group to aspirate a first fluid, and a third group to aspirate a second fluid. Since each group of tubes 61 has only one function, there is no need to wash or clean the tubes between steps.

Again referring to FIG. 7, rotor cover 140 is slidably positioned over rotor 20 by actuator 145. In this embodiment, two actuators each comprise a pneumatic piston that communicate with controller 100. Other devices can be used to position the rotor cover over, and away from the rotor. The rotor cover has a circumferential seal located on the underside of the rotor cover so that when the rotor cover is positioned over the rotor, the seal engages rotor housing 147.

In one embodiment the seal is comprised of rubber and can be expanded by the injection of air, thereby causing the seal to mate with rotor housing 147. In this manner, an air-tight seal can be created between rotor housing 147 and rotor cover 140 to increase centrifugation efficiency by minimizing the movement of air generated by the spinning rotor.

II. Functions of the Automated Centrifuge

With reference to FIGS. 7-11, a description of the discrete functions which the automated centrifuge of the present invention can perform is described below.

Illustrated in FIGS. 8 and 11, operator interface 105 allows a technician to program controller 100 with a “recipe” that is, a list of instructions that directs the controller to perform specific functions appropriate to a specific test. FIG. 11 illustrates a recipe entry screen. In the illustrated embodiment, up to twenty-five or more separate steps can be performed in one recipe. More or less than 25 steps can comprise a recipe, depending upon the requirements of a specific test. Once specific step 195 has been chosen by the operator, a corresponding function is chosen from possible operations box 185.

Once the recipe is finished and all of the steps have been entered by the technician, the recipe can be named and saved in recipe file control box 190. In this manner, hundreds of discrete recipes can be stored for easy access to quickly program the system, thereby saving valuable technician time.

Generally, a first step is to load vessels 45, containing a material for centrifugation, into cavities 25. This can be performed either manually or with the indexer 150 engaged. Illustrated in FIGS. 7, 9 and 10, indexer 150 comprises wheel 155 positioned to contact rotor rim 22. Wheel 155 is driven by indexer motor 152 that communicates with controller 100. An example motor suitable for use as motor 152, that is commercially available is the silver max motor from QuickSilver Controls, Inc. Many other suitable motors are also commercially available.

The indexer motor and wheel are slidably mounted on rotor cover 140 by a pneumatically driven slide that communicates with the controller. In manual mode, the controller instructs the pneumatically driven slide to raise the wheel away from the rotor rim, so that the rotor can easily be spun by hand. In this manner, the rotor can be rotated and vessels can be placed into the cavities.

Alternatively, rotor 20 can be loaded with vessels 45 by configuring the present invention into “index mode.” In index mode, indexer 150 is lowered by controller 100 so that wheel 155 directly contacts rotor rim 22. To keep rotor 20 from tilting when the wheel engages the rotor rim, live center 160 is inserted into rotor post 170, shown in FIG. 10. The live center is connected to sliding mount 165, which communicates with the controller. The sliding mount is optionally pneumatically driven, but other devices can be used to raise and lower sliding mount 165, to disengage or engage live center 160.

Other devices can also be used to raise and lower indexer 150 and wheel 155. When indexer motor 152 is lowered, with wheel 155 contacting rotor rim 22, the controller searches for a first cluster 35. This is accomplished by two optical sensors 180 and 182 that communicate with controller 100, wherein the sensors are mounted on rotor cover 140. The optical sensors tell the controller where the rotor is and the indexing motor moves the rotor around. Alternately, this is replaced with an optical encoder on the rotor shaft and the main drive motor moves the rotor as well as spinning it during centrifugation.

One aspect of the invention is simply the specific positioning of the rotor relative to the rotor chamber. That is, prior art centrifugation systems which simply perform centrifugation do not specifically position the rotor.

Referring to FIGS. 7, 9 and 10, reference optical sensor 180 detects designated first cluster 35, and rim optical sensor 182 detects all of the clusters by reading indexes 40 on rotor rim 22. The rim optical sensor reads the indexes and controller 100 then positions the appropriate cluster that corresponds to each index under tubes 60. In one embodiment, reference optical sensor 180 detects a reference located on rotor 20 that indicates the designated first cluster. Once the first cluster is located, the index wheel 55 rotates the rotor one cluster at a time using information from the rim optical sensor, which reads the indexes located on the rotor rim. In this manner, the first cluster can be determined and each subsequent cluster can be positioned underneath the tubes and rods. Other suitable sensors and methods can be employed to determine the location of each cluster.

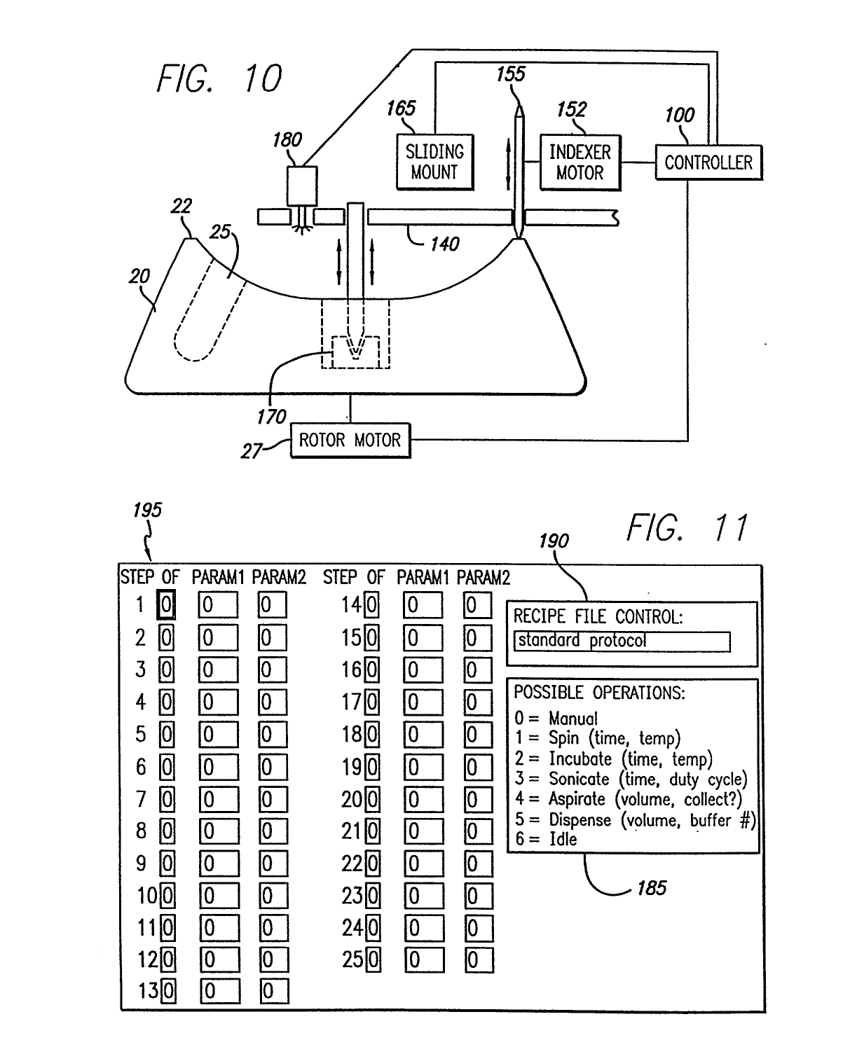

As described above, when the system is configured in index mode, rotor 20 is rotated by wheel 155 so that an operator can insert vessels 45 into cavities 25 without manually turning rotor 20. Illustrated in FIG. 9, rotor control box 200 that communicates with controller 100, controls the movement of the rotor by the above-described system of optical sensors 180 and 182, indexer motor 152 and wheel 155. The rotor control box comprises a open/close switch 205, a rotor rotation button 210, and an emergency stop knob 215. When in index mode, as described above, the optical sensors, working with the indexer motor and wheel position the rotor over a first cluster. A technician can then load the vessels into the four cavities comprising the first cluster. When finished, the technician presses the rotor rotation button, rotating the rotor in a clockwise direction so that the next cluster is positioned for insertion of vessels.

As illustrated in FIG. 9, the rotor rotation button comprises an up-arrow switch that moves rotor 20 in a clockwise direction and a down-arrow switch that moves the rotor in a counterclockwise direction. When the technician has completed inserting vessels 45 into all of the cavities 25 by rotating the rotor one cluster 35 at a time, the technician activates the open/close switch 205 which instructs controller 100 to slide rotor cover 140 over rotor 20. Rotor control box 200 also includes emergency stop knob 215 that cuts power to all the electrically driven devices on the present invention in case of an emergency situation.

Another function of the present invention is the incubation of components or other materials contained in vessels 45 that are located in cavities 25. For example, protein isolation and other laboratory procedures can require the incubation of the proteins. Incubation is accomplished by positioning rotor cover 140 over rotor 20, inflating the rotor seal, and thereby sealing rotor 20 from the environment. A conventional centrifuge cooling system communicates with rotor 20 and temperatures can be accurately maintained in a range between minus 10 degrees centigrade to above 50 degrees centigrade, depending on the application. A centrifuge cooling and heating system can be employed with the automated centrifuge system.

Yet another function of the present invention is the centrifugation of suspended particles located in vessels 45 that have been placed in the cavities 25. This is accomplished by sealing the rotor 20 from the environment by placing the rotor cover 140 over the rotor 20 inflating the rotor seal and spinning the centrifuge rotor 20 thereby separating the suspended particles by their densities.

Still another function performed by automated centrifuge system 10 is the dispensing of buffers, rinses or other fluids into vessels 45 that have been placed in cavities 25. Illustrated in FIGS. 5 and 7, tubes 60 are inserted into vessels 45 by transport 135 that is directed by controller 100. Hose 70 connected to tube 60 carries fluid from pump 80 which obtains the fluid from fluid source 85. Different fluids, such as buffers, washes, or cleansers can be selected from the fluid source by the controller and thereby be dispensed by the pump through the hoses and into the tube and finally into the vessels. In this manner, various fluids can be dispensed into the vessels as part of a bio-molecule (e.g., protein) isolation or other centrifugation procedure. In a preferred embodiment, shown in FIG. 7, fluid can be dispensed into four vessels substantially simultaneously by the four tubes that are positioned over each cavity in a cluster, e.g., containing four cavities 25 in the depicted embodiment. One, two, three, four or more than four vessels 45 can receive fluid from the tubes, depending upon the number of tubes 60 and the arrangement of cavities 25 in rotor 20.

Aspiration of fluids from vessels 45 can be performed by the present invention in a manner similar to the dispensing function described above. Tube 60 is inserted into vessel 45 that is located in cavity 25, and pump 80 is activated to create a vacuum, thereby sucking out the fluid contained in vessel 45. The removed fluid travels through tube 60 into hose 70 through pump 80 and can either be sent to specimen/ fraction collector 110 or to waste dump 90, depending upon the instructions sent by controller 100. For example, after centrifugation, denser material has been forced to the bottom of vessel 45 and the less-dense fluid is aspirated by tube 60 into waste dump 90. Alternatively, a soluble protein maybe suspended in vessel 45 and the soluble protein can be aspirated from vessel 45 by tube 60 and sent to fraction collector 110. The fraction collector is optionally refrigerated, e.g., to prevent sample degradation. At fraction collector 110, the soluble protein fluid is deposited into specimen collectors 120. As discussed above, and illustrated in FIG. 7, aspiration of up to four vessels 45 can be conducted substantially simultaneously by the present invention, drastically reducing the time required for laboratory experiments. The number of vessels 45 that can be aspirated, however, can be varied depending upon the arrangement of tubes 60, and the instructions sent by controller 100.

An additional function performed by the present invention is the sonication of materials located in vessel 45. When one or more vessels are chosen for sonication, sonication rod 65 is inserted into a vessel and controller 100 activates the sonicator. During sonication, the rod is vibrated at a frequency of, e.g., about 20 kilohertz. Other frequencies can be employed for sonication. This creates sound waves which break apart the material located in the vessel. For example, once an initial centrifugation step has been performed, a collection of cells is located near the bottom of the vessel. The sonication rod is inserted into the vessel and the cells are sonicated, which breaks the cells apart, thereby exposing proteins which are later isolated.

In a preferred embodiment, as illustrated in FIG. 7, sonication rod 65 is positioned adjacent to an aspirate/dispense tube 60. In this manner, sonication can be performed immediately after, before or during the dispensing or aspiration of fluids from vessel 45.

A sample recipe will now be described, illustrating one example automated isolation process which can be performed by the present invention. Vessels 45 containing suspended material are placed in cavities 25 in rotor 20. Controller 100 moves rotor cover 140 over centrifuge rotor 20 and rotor 20 is spun by rotor motor 27. Rotor cover 140 is slid back revealing vessels 45. Transport 135 moves tubes 60 and rods 65 into position over a first cluster 35 found by optical sensors 180 and 182. Four tubes 60 are substantially simultaneously inserted into four vessels 45 and fluid located therein is aspirated into waste dump 90. The tubes are removed by the transport, indexing motor 152 rotates index wheel 155 to a next cluster 35 and this procedure is repeated until all of the fluid in all of the vessels is removed.

The vessels are then removed by a technician and frozen, which breaks up many of the cells located in the pellet, which is formed in the bottom of the vessel as a result of the centrifugation. After freezing, the vessels are again loaded into cavities 25 in rotor 20. Controller 100 instructs transport 135 to position tubes 60 into vessels 45 and a selected buffer is dispensed into each vessel. Also, sonication rod 65 is simultaneously inserted with tube 60 and the pellet is sonicated, thereby disbursing the components of the pellet into the buffer fluid. This fluid dispensing and sonication procedure is performed on all vessels 45 that are contained in rotor 20.

Rotor cover 140 is positioned over rotor 20 and rotor and vessels 45 are incubated. Rotor cover 140 is then slid away from rotor 20 and sonication rods 65 are inserted into vessels 45 and activated to resuspend the cells. The sonication rods are removed by transport 135, the rotor cover is positioned over the rotor, and the rotor is then spun to centrifuge the materials contained in the vessels.

Now, tubes 60 are inserted into vessels 45 and the fluid is aspirated out into fraction collector 110. The material aspirated may contain soluble proteins as part of a protein isolation procedure. After depositing fluid into fraction collector 110, the hoses 70 can be rinsed by flushing fluid from the fluid source 85 through hoses 70 and through tubes 60 into waste dump 90 located adjacent to centrifuge rotor 20. After the flushing procedure, controller 100 activates pump 80 to aspirate the rinsing solution into the waste dump 90. Tubes 60 are inserted into the vessels and a selected buffer from the fluid source is inserted into the vessels. Sonication rod 65 is then activated, sonicating the recently dispensed buffer and the materials still remaining in the vessels.

Tube 60 and rod 65 are removed from vessel 45 and rotor 20 is spun, thereby centrifuging sample in vessel 45. The tube is again inserted into the vessel and supernatant fluid is aspirated into waste dump 90, using pump 80.

This process of dispensing buffer, sonicating, centrifuging and aspirating waste fluid can be repeated as many times as necessary to further purify remaining proteins left after centrifugation. In one recipe, remaining insoluble proteins located in vessel 45 can be dissolved by instructing tube 60 to dispense a buffer designed to place the insoluble proteins into solution, such as GB buffer, described above. Again, these materials are sonicated either during dispensing of the buffer or shortly thereafter. They are also centrifuged and supernatant fluid is aspirated by tube 60. The aspirated fluid is deposited into fraction collector 110 and into specimen collectors 120. The order of dispensing fluid, sonicating, incubating, aspirating can be changed or varied depending upon the requirements by the user.

III. An Alternative Automated Centrifuge System

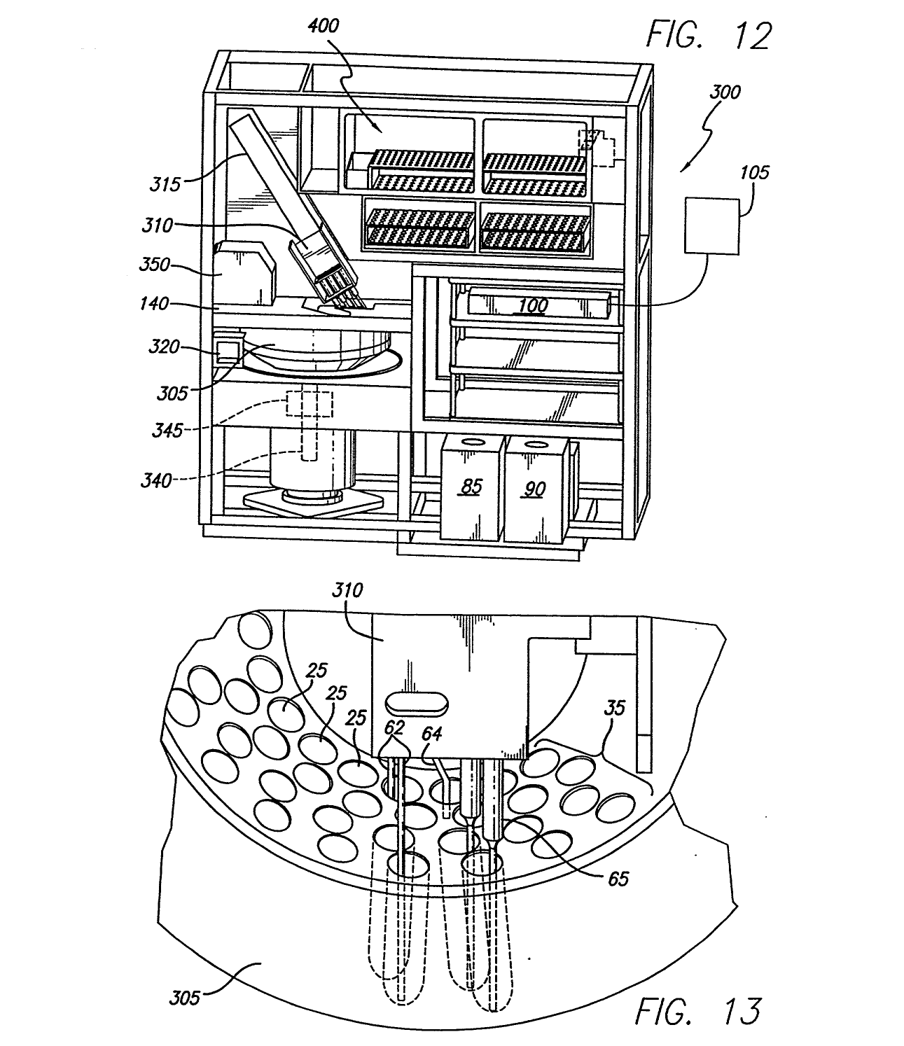

Referring to FIG. 12, an alternative embodiment automated centrifuge system 300 is shown. In this embodiment, the automated centrifuge system 300 comprises large rotor 305 containing a plurality of clusters 35 of cavities or holes 25 arranged to cooperate with aspirate tubes 62, dispense tubes 64 and rods 65, shown in FIG. 13. Tubes 62 and 64 and rods 65 are mounted on moveable head 310 that rides on track 315. Moveable head 310 can position tubes 62 and 64 and rods 65 into or adjacent to cavities 25. When inserted into cavities 25, aspirate tubes 62 can aspirate fluids from one cluster 35 of cavities 25 while rods 65 sonicate fluid in second cluster 35 of cavities 25. Dispense tubes 64 are arranged to dispense fluid into the second cluster of cavities. In a preferred embodiment, the aspiration and sonication operations can occur substantially simultaneously. The aspiration, sonication and dispense operations can be performed substantially simultaneously, or in any order necessary to efficiently process fluid samples. In this manner, the efficient automated processing of a large number of discrete fluid samples can be performed without substantial human intervention.

Automated centrifuge system 300 illustrated in FIG. 12 eliminates many components of the above-described automated centrifuge system 10, resulting in the faster processing of fluids or substances deposited in cavities 25. While employing many of the concepts and components of automated centrifuge system 10, described in detail above, automated centrifuge 300 eliminates many components, resulting in a machine that processes fluid samples faster, yet costs less to construct and operate. In particular, the indexing system for determining the position of rotor 20 and rotor control box 200 is removed from the embodiment illustrated in FIG. 12. Automated centrifuge system 300 employs rotor position sensor 345. This replaces several components, including: index 40, indexer 150, index motor 152, index wheel 155, live center 160, sliding mount 165, reference optical sensor 180 and rim optical sensor 182. In this embodiment, rotor motor 27 is controlled by controller 100 to perform both centrifugation and rotor positioning.

In a preferred embodiment, the rotor position sensor 345 is a rotary optical encoder. Other types of devices used for measuring the rotation and position of rotor shaft 340 can be employed, such as inductive angle measuring devices, resolvers and other similar apparatus. Rotor position sensor 345 is positioned on rotor shaft 340 and communicates with controller 100 which is operated through operator interface 105. Certain available controllers or controller components can be used to direct rotor positioning and/ or centrifugation by rotor motor 27, e.g., the 2400 modular performance AC drive available, e.g., from UNICO, Inc. (Franksville, Wis.). As discussed above, the operator interface allows a technician to program the controller with a “recipe” which is a list of instructions that tells the controller to perform specific functions appropriate to a specific task. For example, a component such as a protein that is suspended in a fluid may need to be isolated through a centrifugation process. The technician programs the appropriate “recipe” into the controller and then proceeds to load vessels 45 into large rotor 305.

Referring to FIG. 12, once a recipe has been entered through operator interface 105 and into controller 100, the controller determines the position of rotor 305 through rotor position sensor 345. The technician inserts vessels 45 into cavities 25 and then places both hands on the switch 320. The rotor is then rotated, presenting a new cluster 35 of cavities 25 for loading. Switch 320 provides an important safety feature by forcing the technician to place his hands on the switch before the rotor is rotated. This avoids any possible injury to the technician, by keeping his hands well away from the rotating rotor. In a preferred embodiment, switch 320 comprises one or more touch buttons. Touch buttons register an operators touch, converting that touch into an electrical output that signals the controller to rotate the rotor. Other types of safety switches such as capacitive and photoelectric sensors and other suitable devices can be employed in place of the switch. Ordinarily, there are 2 touch buttons, i.e., one for each of an operator's hands. Thus, an operator places 2 hands on the touch buttons, ensuring that the operators hands are out of any danger from the rotor before engaging the rotor.

After placement of vessels 45 into cavities 25, rotor cover 140 is positioned over rotor 305. Rotor 305 is then spun, separating the different components through a centrifugation process. When the centrifugation process is complete, rotor 305 is stopped. Controller 100 then instructs rotor cover 140 to slide away, revealing rotor 305.

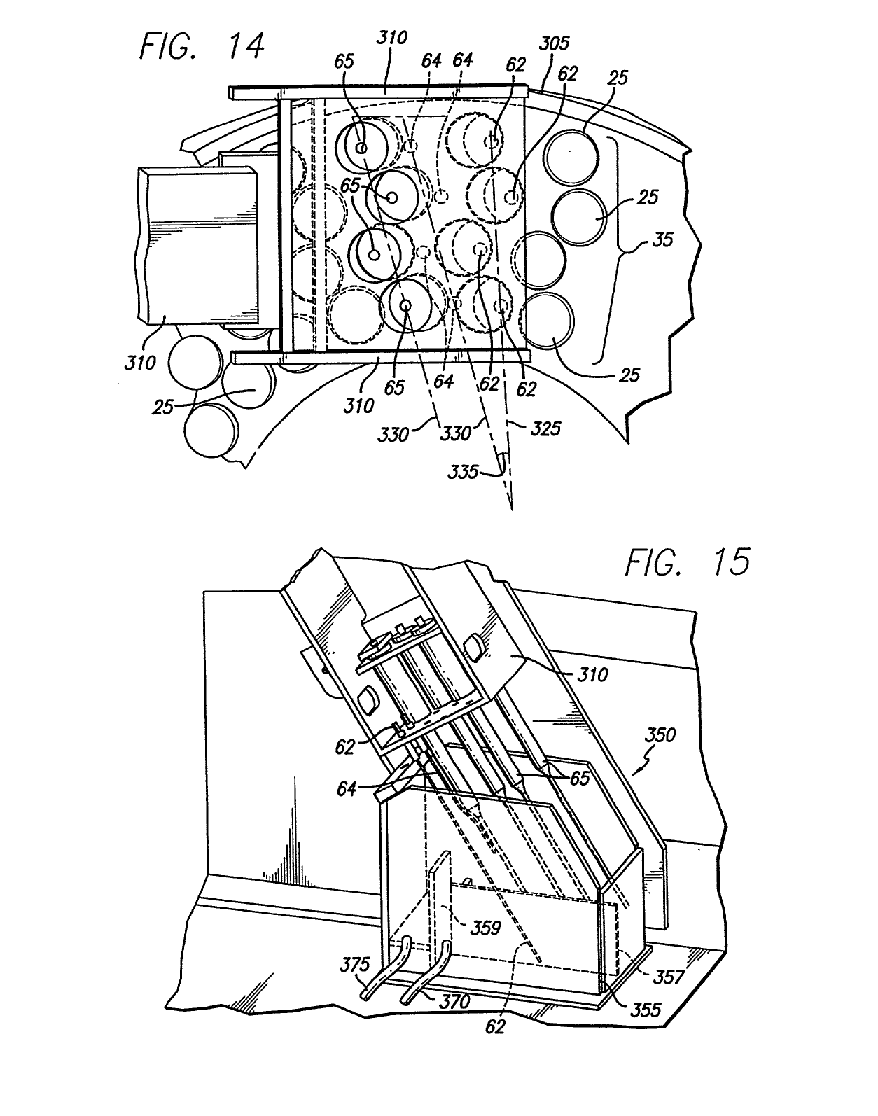

Referring now to FIGS. 13-14, the insertion of the aspirate tubes 62, dispense tubes 64, and rods 65 into cavities 25 will now be described. In one preferred embodiment, rotor 305 contains ninety-six cavities 25 arranged in twenty-four clusters 35 of four cavities 25. As shown in FIG. 14, the cavities are arranged substantially radially on rotor 305. As discussed above, the longitudinal axes of all of the cavities of each cluster are substantially parallel, thereby permitting the substantially simultaneous insertion of one or more of the rods, aspirate tubes and/or dispense tubes.

Referring to FIG. 14, one arrangement of rods 65 and aspirate tubes 62 and dispense tubes 64 is illustrated. Four aspirate tubes, four dispense tubes and four rods are mounted on movable head 310. In a preferred embodiment, the dispense tubes and rods have parallel tube axes 330. The aspirate tubes are arranged on a tube axis 330 that is angled 335 relative to the dispense tube axis. The angle allows the aspirate tubes and rods to be substantially simultaneously inserted into two adjacent clusters 35. This allows the aspiration of fluids from one cluster 35 of cavities 25 and the simultaneous sonication of an adjacent cluster of cavities. Shown in FIG. 13, the dispense tubes are significantly shorter than the aspirate tubes 62 and can be arranged to dispense fluid into the same cavities that the rods are positioned in. Other arrangements of aspirate tubes and dispense tubes and cavities can be constructed, such as positioning tubes 62 and rods 65 in a splayed arrangement so that three or more clusters 35 of cavities 25 can be substantially simultaneously serviced.

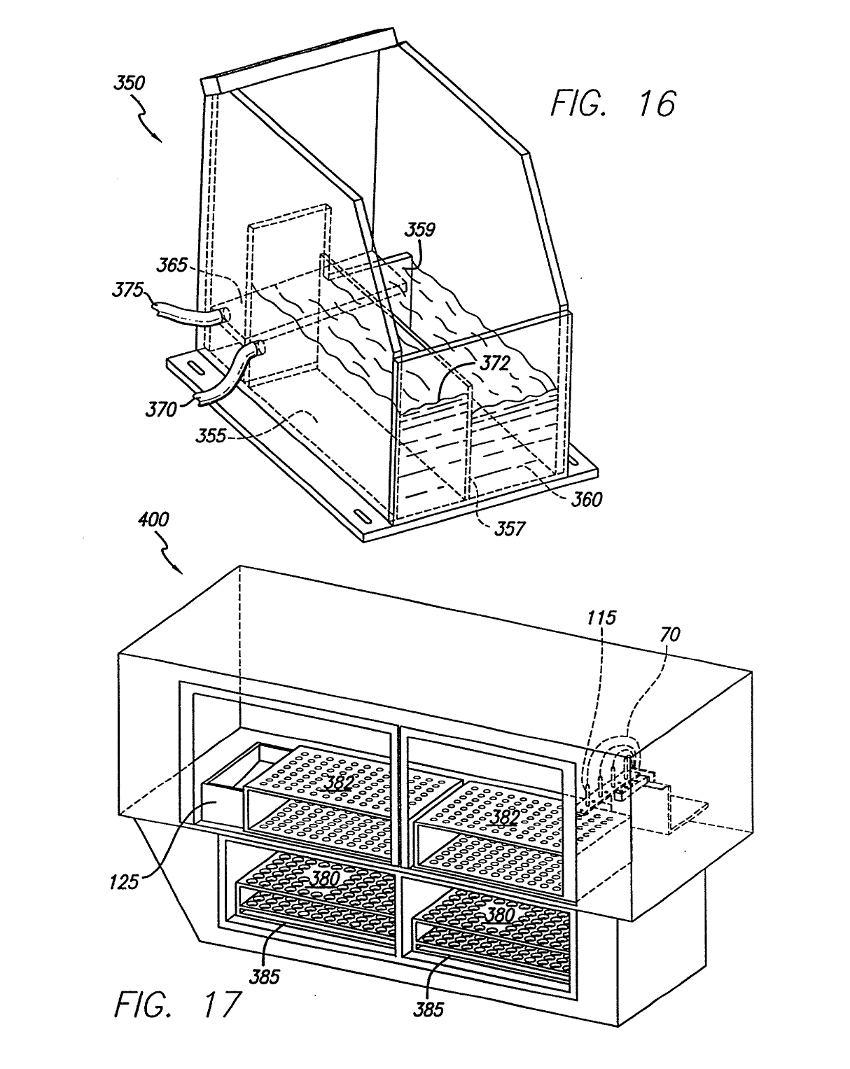

Referring to FIGS. 15-16, waste/rinse container 350 is illustrated. After tubes 62 and 64 and rods 65 have performed their functions in cavities 25, rotor cover 140 is slid over rotor 305. This positions the waste/rinse container under movable head 310. The moveable head is then transported down track 315 and tubes 62 and 64 and rods 65 are positioned in the waste/rinse container. Aspirate tubes 62 are inserted into tube bin 355 with rods 65 inserted into rod bin 360. Dispense tube 64 does not need rinsing, as it does not need to contact fluids or other substances in the cavities. Fluid source 85 delivers fluid through rinse fluid input 37 and into tube bin 355. Rinse fluid 370 can be dionized water, alcohol, detergent, or any other suitable rinsing fluid. Rinse fluid 370 washes aspirate tube 62 and, if necessary, aspirate tubes 62 can aspirate rinse fluid 370 and dump it into waste dump 90. The rinse fluid fills the tube bin and then overflows into rod bin 360 where it rinses sonication rod 65. Dispense tube 64 can dispense fluids into rinse fluid 370, which then runs down run-off ramp 365 to rinse fluid exit 375 and to waist dump 90 through tubes or other means that are not illustrated.

Referring to FIG. 17, fraction collector 400 is illustrated. Fraction collector 400 is structured to collect sample components that have been isolated during a centrifugation process. Tips 115, that are connected to hoses 70, deposit isolated material obtained from cavities 25 by aspirate tubes 62 into filter bed 382, preferably arranged in a standard ninety-six, three hundred eighty four, or one thousand five hundred thirty six member sample format. The fraction collector optionally comprises one or more additional tips or sets of tips that dispense fluid from sources other than the cavities. Hoses 70 communicate with aspirate tubes 62 as described above. In a preferred embodiment, filter bed 382 comprises a plurality of vessels, each comprising a filter structured to remove particles that have not been separated during the centrifugation process. For example, nitrocellulose filters or Whatman filters or sepharose resin filters or other suitable filters can be employed.

After passing through filter bed 382, the fluid then drops down onto resin bed 380, which preferably is arranged in standard format such as a ninety-six, three hundred eighty four, or one thousand five hundred thirty six member sample format. Resin bed 380 is structured to catch the components that have been isolated during the centrifugation process. For example, proteins that have passed through the filter bed 382 are now caught in resin bed 380. In a preferred embodiment, a nickel chelate resin is employed, but other types of resins, such as ion-exchange resins and hydrophobic interaction resins, can be employed. Located beneath resin bed 380 is catch tray 385 that catches any remaining fluids and deposits them in waste dump 90.

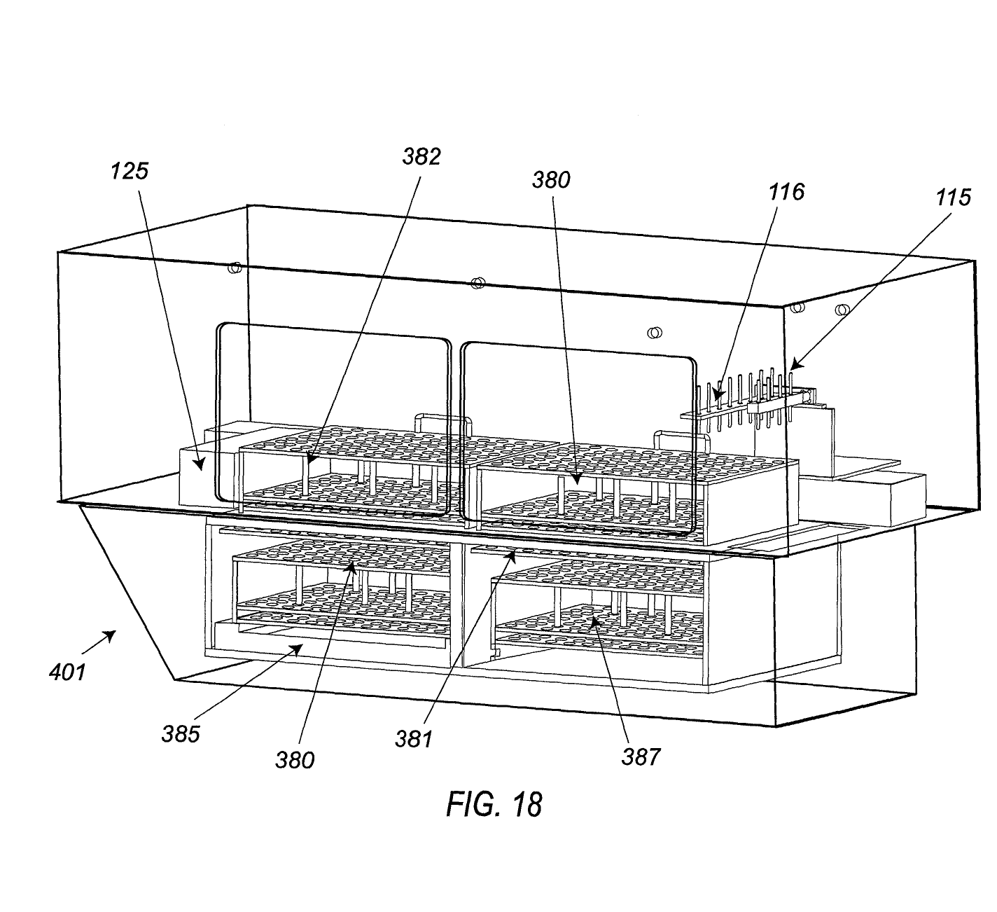

FIG. 18 illustrates an alternate fraction collector embodiment which omits the need for a filter tray (right side of drawing). Fraction collector 401 is illustrated, schematically showing two different configurations of collector component options on the left and right side of the drawing. The left side of the drawing is configured as in FIG. 17 for comparative purposes. The right side represents a different collector configuration. In practice, either the left side configuration, or the right side configuration, or both, can be used for any given collector. As illustrated on the right side of the drawing, fraction collector 401 is structured to collect sample components that have been isolated during a centrifugation process. Tips 115 that are connected to hoses 70 deposit isolated material obtained from cavities 25 by aspirate tubes 62 into tips 115 which dispense material into resin bed 380 comprising resin bed rack 379 and resin bed columns 378. Resin bed 380 is depicted schematically. As shown, only a few resin columns are placed in the bed. However, in use, resin bed 380 can comprise resin columns 378, in any or all of the holes in rack 379. In one embodiment, the columns comprise a nickel chelate resin, but it will be appreciated that any other appropriate purification material can be substituted in the column, depending on the material to be purified. Additional tips 116 are connected to buffer or other fluid sources and dispense fluids into resin bed 384 to provide for washing or rinsing of materials on the columns, and/ or separation of the materials from the columns (e.g., by applying a cleavage reagent). For example, when dispensing washing fluid, waste collection tray 381 located under resin bed 380 collects waste from the resin bed. The waste collection tray is coupled to waste dump 190 and provides for delivery of waste from the resin bed to the waste dump. When tips 116 dispense a material which provides for separation of desired components from the resin bed, waste collection tray 381 is placed in a non-collecting position and fluid comprising the sample of interest (e.g., a purified protein) drops into collection rack 387. Collection tube rack 387 is located beneath the waste collection tray and collects sample components such as purified protein components or the like, e.g., in collection tubes or microtiter trays placed in the rack. Any or all of these beds or trays can be arranged in a standard format, e.g., in a 96, 384, or 1536 well arrangement to provide for simplified processing and collection of purified materials.

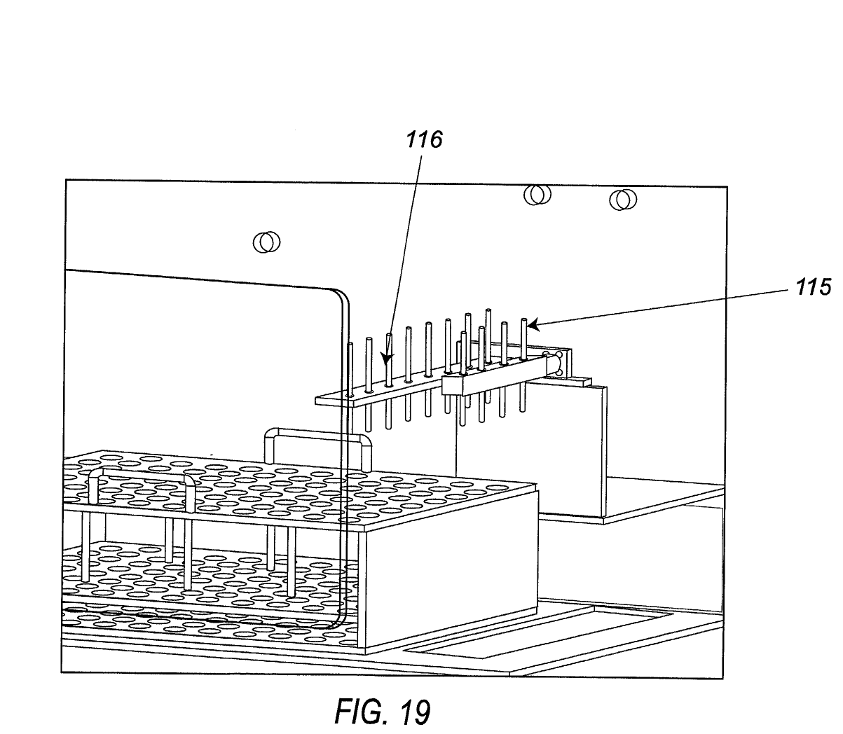

FIG. 19 provides details on the arrangement of tips 115 and 116 in one example embodiment which can apply to any of the sample/ fraction collector embodiments noted above. Tips 115 are fluidly coupled to sample processing elements, while tips 116 are coupled to fluid sources that provide wash, rinse, cleavage or other solutions of interest to the collector.

Also shown in FIG. 12 is controller 100. As discussed above, the controller optionally comprises a general purpose computing device that controls a function of automated centrifuge 300. In one embodiment, the automated centrifuge employs a controller that comprises two programmable logic controllers (PLCs) with one PLC operating operator interface 105 and directing the second PLC to perform the variety of functions of the automated centrifuge 300. In an alternate similar embodiment, one PLC controls the fraction collection functions for the fraction collector noted above while another controls the user interface, the main rotor functions, and, optionally, controls the PLC that controls the fraction collector functions. The number, function and arrangement of PLC can vary, depending on the system components and the operations that the overall system performs.

One skilled in the art will appreciate that the present invention can be practiced by other than the preferred embodiments which are presented in this description for purposes of illustration and not of limitation, and the present invention is limited only by the claims that follow. It is noted that equivalents for the particular embodiments discussed in this description are also within the scope of the present invention.

All patents, patent applications, publications and other documents cited above are incorporated by reference for all purposes as if each patent, patent application, publication and/or other document were specifically indicated to be incorporated by reference.

What is claimed is:

1. An automated centrifuge system, comprising:
(a) at least a first rotor comprising a plurality of sample receiving regions; and,
(b) at least one transport mechanism configured to move one or more sample processing components proximal to or within the plurality of sample receiving regions;
(c) at least one robot capable of inserting at least two sample vessels into the sample receiving regions at substantially the same time; or
(d) both (b) and (c).

2. The automated centrifuge system of claim 1, wherein the rotor comprises or is operably coupled to a rotor position sensor which determines the relative position of the sample receiving elements.

3. The automated centrifuge system of claim 2, wherein the rotor position sensor is a rotary optical encoder.

4. The automated centrifuge system of claim 1, wherein the rotor is mounted within a centrifuge chamber comprising a rotor cover configured to mate with a top surface of the centrifuge chamber.

5. The automated centrifuge system of claim 1, wherein the rotor comprises or is operably coupled to a reference index which facilitates positioning of a cluster of sample receiving elements in the rotor relative to a group of sample processing components coupled to the transport.

6. The automated centrifuge system of claim 5, wherein system comprises a first motor which spins the rotor to position the clusters according to the reference index.

7. The automated centrifuge system of claim 5, wherein system comprises a second motor which spins the rotor during sample centrifugation.

8. The automated centrifuge system of claim 5, wherein the first motor is configured to spin the rotor during sample centrifugation.

9. The automated centrifuge system of claim 1, wherein the sample receiving regions are configured to receive a centrifuge tube.

10. The automated centrifuge system of claim 1, wherein the sample receiving regions are arranged in clusters, each sample receiving region in a given cluster comprising a longitudinal axis substantially parallel to other sample receiving regions in the cluster.

11. The automated centrifuge system of claim 1, wherein the sample receiving regions are arranged in a plurality of clusters each comprising a plurality of sample receiving regions, each sample receiving region in each cluster having substantially parallel longitudinal axes.

12. The automated centrifuge system of claim 1, wherein the cluster comprises at least four sample receiving elements.

13. The automated centrifuge system of claim 1, wherein there are between two and ten sample receiving elements in the cluster.

14. The automated centrifuge system of claim 1, wherein the system comprises a group of sample processing components.

15. The automated centrifuge system of claim 14, wherein the transport is configured to substantially simultaneously insert the group of sample processing components into a cluster of sample receiving regions.

16. The automated centrifuge system of claim 14, wherein the group of sample processing components perform at least 2 different sample processing operations.

17. The automated centrifuge system of claim 14, wherein the group of sample processing components perform sample processing operations on at least 3, at least 4, at least 6, at least 8, at least 16, or at least 32 different samples at the same time.

18. The automated centrifuge system of claim 14, wherein the group of sample processing components are arranged in at least two groups of components, wherein each group is configured to be inserted into adjacent clusters of sample receiving elements.

19. The automated centrifuge system of claim 14, wherein the sample processing components comprise one or more sample processing component configured to transport at least one fluid.

20. The automated centrifuge system of claim 14, wherein the sample processing components are configured to selectively perform an operation selected from the group consisting of: aspiration of material away from at least one of the sample receiving elements, dispensation of material into at least one of the sample receiving elements, vibrating a material in at least one of the sample receiving elements, measuring a property of a material in at least one of the sample receiving elements, aspiration of material away from a cluster of sample receiving elements, dispensation of material into a cluster of sample receiving elements, vibrating a material in a cluster of sample receiving elements, and measuring a property of a material in a cluster of sample receiving elements.

21. The automated centrifuge system of claim 14, wherein the sample processing components comprise one or more sample processing components selected from the group consisting of: a fluid aspiration tube, a fluid dispensing tube, a rigid tube, a flexible tube, a vibrating member, and a sonication rod.

22. The automated centrifuge system of claim 14, wherein a plurality of the sample processing components in the group together comprise a plurality of sonication rods configured to be inserted into the sample receiving regions and a plurality of tubes configured to transport at least one fluid to or away from the sample receiving regions.

23. The automated centrifuge system of claim 14, the rotor comprising clusters of sample receiving elements, wherein the group of sample processing components is arranged in pairs of components, so that when the group is moved into a first cluster of sample receiving elements, at least one pair of sample processing components is inserted into at least one pair of corresponding sample receiving elements in the cluster.

24. The automated centrifuge system of claim 1, wherein the at least one robot comprises a gripper mechanism configured to grasp the outside surface of a sample vessel to be inserted into the sample receiving regions.

25. The automated centrifuge system of claim 1, wherein the robot comprises a gripper mechanism configured to grasp the inside surface of a sample vessel to be inserted into the sample receiving regions.

26. The automated centrifuge system of claim 1, wherein the sample receiving elements are arranged in clusters and the robot is configured to position at least 2 centrifuge vessels into receiving elements in at least one cluster at the same time.

27. An automated centrifuge system of claim 1, wherein the sample receiving elements are arranged in clusters and the robot is configured to position at least 4, at least 8, at least 16, or at least 32 centrifuge vessels into receiving elements in at least one cluster at the same time.

28. The automated centrifuge system of claim 1, wherein the robot is capable of removing a plurality of sample vessels from a plurality of sample receiving elements at the same time.

29. The automated centrifuge system of claim 1, the system further comprising system software which controls rotation of the rotor relative to the robot such that the robot is capable of positioning centrifuge vessels into sample receiving elements of different clusters of the centrifuge rotor.

30. The automated centrifuge system of claim 1, comprising at least one controller operably coupled to the transport, the robot, or both the transport and the robot, wherein the controller is configured to perform at least one operation selected from the group of operations consisting of: directing the transport to deliver one or more materials to the one or more sample receiving regions, directing the robot to deliver a plurality of sample vessels to the sample receiving regions, and directing the transport to move the sample processing components proximal to or within the sample receiving regions.

31. The automated centrifuge system of claim 30, wherein the controller directs the transport to insert a plurality of the sample processing components into the plurality of sample receiving regions.

32. The automated centrifuge system of claim 30, wherein the rotor comprises a cluster of sample receiving elements and the transport is coupled to a group of sample processing components, wherein the controller directs the transport to insert the group of sample processing components into the cluster of sample receiving elements.

33. The automated centrifuge system of claim 30, wherein the controller comprises one or more controller components selected from the group consisting of: a computer, a programmable logic controller, system software, a user interface, and a network of computers.

34. The automated centrifuge system of claim 30, wherein the controller is configured to control rotation of the rotor.

35. The automated centrifuge system of claim 30, further comprising an index, wherein the controller references the index to position a cluster of sample receiving elements relative to a set of sample vessels or relative to a set of sample processing components, or both.

36. The automated centrifuge system of claim 30, wherein the controller directs the transport to insert and remove a group of sample processing components into a cluster of sample receiving elements, and further directs a rotor positioning mechanism to rotate the rotor relative to the group of sample processing components until another cluster is proximal to the group.

37. The automated centrifuge system of claim 30, wherein the controller directs the transport to insert and remove groups of sample processing components into adjacent clusters of sample receiving elements, and further directs a rotor positioning mechanism to rotate the rotor relative to the groups until another cluster or pair of adjacent clusters is proximal to the groups.

38. The automated centrifuge system of claim 30, the system comprising system software which controls rotation of the rotor relative to the robot, or the transport, or both the robot and the transport such that the robot is capable of positioning vessels in the rotor or such that the transport is capable of inserting sample processing components into the sample receiving elements, or both.

39. The automated centrifuge system of claim 30, further including a pair of operator safety members that communicate with the controller, wherein the members, when activated, permit rotation of the rotor.

40. The automated centrifuge system of claim 39, wherein the pair of operator safety members are selected from the group consisting of: a pair of switches, a pair of buttons, and a pair of touch buttons.

41. The automated centrifuge system of claim 1, comprising means for recognizing a sample or sample vessel when the sample or sample vessel is moved to the sample receiving region, means for recognizing the sample processing component when the sample processing component is moved proximal to or within the sample receiving region, or both, and an indexing means for tracking the sample, the sample processing component, or both, when the sample or sample processing component is moved from the sample receiving region to a different region of the automated centrifuge system, or to a separate system or device.

42. The automated centrifuge system of claim 1, the system comprising logic for tracking which sample vessels are located in which sample receiving elements.

43. The automated centrifuge system of claim 1, the system further comprising logic for tracking what sample processing operations are performed on a sample or sample vessel.

44. The automated centrifuge system of claim 1, further comprising one or more sample vessel structured to be insertable into at least one of the sample receiving regions, which one or more vessel contains one or more sample and comprises one or more mating feature, which mating feature mates with a corresponding mating feature of the robot.

45. The automated centrifuge system of claim 1, further comprising:
a second rotor, the second rotor comprising a cluster of sample receiving elements; and,
a movable platform coupled to the transport or the robot; wherein the movable platform moves the transport or the robot to selectively position the sample vessels, the sample processing components, or both, for insertion of the sample vessels, the sample processing components, or both, into the sample receiving elements of the first rotor or the cluster of sample receiving elements in the second rotor, or both.

46. The automated centrifuge system of claim 1, further comprising a rinse container structured to contain a fluid, which rinse container is configured to accept the sample processing components, wherein the transport positions the sample processing components in the rinse container, thereby rinsing the components.

47. The automated centrifuge system of claim 46, wherein the rinse container comprises a tube bin, a rod bin and a runoff ramp.

48. The automated centrifuge system of claim 1, wherein the sample processing components are configured to remove a material from the sample receiving regions.

49. The automated centrifuge system of claim 48, wherein the sample processing components are fluidly coupled to a specimen collector, wherein, during operation of the system, the material is flowed from the sample processing component to the specimen collector.

50. The automated centrifuge system of claim 48, wherein the sample processing components are fluidly coupled to a sample purification component.

51. The automated centrifuge system of claim 48, wherein the sample processing components are fluidly coupled to a resin bed.

52. The automated centrifuge system of claim 51, wherein the resin bed comprises a plurality of purification columns comprising a nickel chelate resin.

53. The automated centrifuge of claim 49, wherein the specimen collector comprises a collection component selected from the group consisting of: a filter, a nitrocellulose filter, a vessel, a resin, a resin bed, an ion-exchange resin and a hydrophobic interaction resin.

54. The automated centrifuge system claim 49, wherein the specimen collector or the rotor or both are refrigerated.

55. The automated centrifuge system of claim 49, wherein the specimen collector comprises a fraction dispensing element, a resin bed into which material can be flowed from the fraction dispensing element, a collection tube rack which collects material from the resin bed, and a waste collection tray coupled to a waste dump.

56. The automated centrifuge system of claim 1, comprising at least a second transport configured to transport a second group of sample processing components.

57. The automated centrifuge system of claim 1, comprising:
one or more sample processing components;
one or more hoses coupled to the sample processing components, which hoses are configured to receive material transported from the sample receiving regions through the sample processing components;
one or more tips coupled to the one or more hoses;
a pump operatively coupled to the one or more hoses or to the one or more tips;
a fluid source fluidly coupled to the sample processing elements;
a specimen collector arranged to receive material from the one or more tips;
a switch which controls fluid flow between the fluid source and the sample processing elements or between the sample processing elements and the hoses or tips; and,
a waste dump configured to receive waste from the sample processing elements, the fraction collector, the tips, the hoses, the sample processing components, the sample receiving elements, vessels inserted into the sample receiving elements, the fluid source, or any combination thereof.

58. The automated centrifuge system of claim 1, comprising a centrifuge.

59. A centrifuge rotor, comprising:
a rotor body comprising at least one cluster of sample receiving elements disposed therein, wherein the cluster comprises a plurality of sample receiving elements comprising substantially parallel longitudinal axes.

60. The centrifuge rotor of claim 59, wherein the longitudinal axes are less than completely vertical.

61. The centrifuge rotor of claim 60, wherein the longitudinal axes are at least 1° less than vertical.

62. The centrifuge rotor of claim 60, wherein the longitudinal axes are at least 5° less than vertical.

63. The centrifuge rotor of claim 59, wherein the clusters comprise spatially grouped sample receiving elements.

64. The centrifuge rotor of claim 59, wherein the rotor body comprises a plurality of clusters, each comprising a plurality of sample receiving elements comprising substantially parallel longitudinal axes.

65. The centrifuge rotor of claim 59, wherein there are between two and ten sample receiving elements in the cluster.

66. The centrifuge rotor of claim 59, wherein there are between 10 and 200 sample receiving elements in the rotor body.

67. The centrifuge rotor of claim 59, wherein there are between 8 and 40 clusters of sample receiving elements in the rotor body, each comprising a plurality of sample receiving elements comprising substantially parallel longitudinal axes.

68. The centrifuge rotor of claim 59, wherein each sample receiving element is capable of housing a vessel having a volume of at least about 10 mL.

69. The centrifuge rotor of claim 59, wherein each sample receiving element is capable of housing a vessel having a volume of at least about 100 mL.

70. The centrifuge rotor of claim 59, wherein the sample receiving elements are configured to accept a centrifuge tube.

71. The centrifuge rotor of claim 59, wherein the cluster of sample receiving elements is arranged to substantially simultaneously receive a group of movable sample processing components held by a transport.

72. A method of treating one or more samples in a centrifuge rotor, the method comprising:
(a.) placing a sample into a sample vessel;
(b.) inserting the sample vessel into a centrifuge rotor;
(c.) rotating the rotor, thereby centrifuging the sample in the sample vessel; and,
(d.) performing one or more sample treatment operation on a component of the sample in the vessel, while the vessel is inserted into the centrifuge rotor.

73. The method of claim 72, wherein (a.) is performed after (b.).

74. The method of claim 72, wherein (b.) is performed after (a.).

75. The method of claim 72, wherein (b.) comprises placing a plurality of vessels into the centrifuge rotor.

76. The method of claim 72, wherein (d.) comprises at least one sample treatment operation selected from the group consisting of: aspirating supernatant from the vessel while the vessel located in the centrifuge rotor, delivering fluid to the vessel while the vessel is located in the centrifuge rotor, and sonicating the component within the vessel while the vessel is located in the centrifuge rotor sample receiving element.

77. The method of claim 72, wherein (d.) comprises removing a material from the vessel while the vessel is located in the centrifuge rotor sample receiving element and depositing the material into a specimen collector.

78. The method of claim 72, wherein (d.) comprises performing at least two different operations on at least two different sample vessels, wherein the operations are selected from the group of operations consisting of: dispensing fluid into at least one of the sample vessels, suspending a sample component in at least one of the sample vessels, and aspirating fluid from at least one of the sample vessels.

79. The method of claim 72, wherein (d.) comprises simultaneously performing a plurality of operations on a plurality of sample components distributed in a plurality of sample vessels.

80. The method of claim 72, wherein (d.) comprises simultaneously performing a plurality of different operations on a plurality of sample components distributed in a plurality of sample vessels.

81. The method of claim 72, further comprising:
transporting a sample component from the vessel, while the vessel is located in the centrifuge rotor, to a specimen or fraction collector, or to a sample purification component.

82. The method of claim 81, wherein the specimen collector comprises one or more component selected from the group consisting of: a filter, an array of filters, a nitrocellulose filter, and array of nitrocellulose filters, a vessel, a resin, a nickel chelate resin, a resin bed, an ion-exchange resin, a waste rack, a waste dump, and a hydrophobic interaction resin.

83. The method of claim 72, further comprising:
recognizing the vessel when the vessel is inserted into the rotor and tracking the vessel when it is transferred from the centrifuge rotor to a separate system or device.

84. The method of claim 72, wherein the sample vessel is inserted into the rotor with a robot and wherein the sample treatment operation is performed with one or more sample treatment components which are coupled to a transport.

85. A method of centrifuging a sample, the method comprising:
providing a rotor comprising a plurality of clusters of sample receiving elements;
loading at least one sample into at least one of the plurality of clusters; and,
rotating the rotor, thereby centrifuging the sample.

86. The centrifuge rotor of claim 85, wherein the longitudinal axes of the sample receiving elements in the clusters are less than completely vertical.

87. The centrifuge rotor of claim 86, wherein the longitudinal axes are at least 1° less than vertical.

88. The centrifuge rotor of claim 86, wherein the longitudinal axes are at least 5° less than vertical.

89. The centrifuge rotor of claim 85, wherein the clusters comprise spatially grouped sample receiving elements.

90. The method of claim 89, wherein each cluster comprises at least four substantially parallel sample receiving elements.

91. The method of claim 85, wherein the rotor comprises between 8 and 40 clusters, each comprising between 2 and 10 sample receiving elements.

92. The method of claim 85, wherein the sample is contained within a centrifuge tube, wherein the tube is loaded into the rotor, thereby loading the sample into the rotor.

93. The method of claim 85, comprising inserting a group of sample processing components into at least one selected cluster.

94. The method of claim 93, wherein the group of sample processing components is coupled to a transport that inserts the group into a selected cluster.

95. The method of claim 93, wherein the group of sample processing components are simultaneously instated into the selected cluster.

96. The method of claim 93, wherein the group of sample processing components performs a plurality of sample processing functions on materials contained within the selected cluster.

97. The method of claim 93, wherein the group of sample processing components are arranged so that when the group is inserted into the cluster, at least one sample processing component is inserted into each sample receiving element within the cluster.

98. The method of claim 93, wherein the group of sample processing components perform sample treatment functions on at least 3, at least 4, at least 6, at least 8, at least 16 or at least 32 different samples at substantially the same time.

99. The method of claim 93, wherein the group of sample processing components perform at least 2 different sample processing operations simultaneously.

100. The method of claim 93, further comprising removing the sample processing components, rotating the rotor, and re-inserting the set of sample processing components, wherein the sample processing components, after re-insertion, perform at least one operation selected from the group of operations consisting of: aspirating supernatant, delivering fluid to the sample receiving elements, and sonicating a sample component in the sample receiving element.

101. The method of claim 93, wherein the operation performed is selected from the group consisting of: aspirating supernatant, removing material from the sample receiving elements, dispensing material into the sample receiving elements, vibrating the sample, sonicating the sample, and measuring a property of the sample.

102. The method of claim 93, comprising positioning the cavities relative to the sample processing components using a reference index.

103. The method of claim 85, comprising removing liquid from the sample receiving elements, and depositing the liquid into a specimen collector.

104. The method of claim 85, comprising:
robotically attaching a plurality of centrifuge vessels to an arm of a robot;
moving the arm adjacent to the rotor; and,
robotically inserting the plurality of centrifuge vessels into a selected cluster, at the same time.

105. The method of claim 104, wherein the centrifuge vessels comprise the sample.

106. The method of claim 104, wherein the robot simultaneously inserts at least 3, least 4, at least 8, at least 16, or least 32 centrifuge vessels into the plurality of clusters, at the same time.

107. The method of claim 104, further comprising:
robotically attaching a second plurality of centrifuge vessels to the arm of the robot; and,
robotically inserting the second plurality of centrifuge vessels into a different selected cluster of the centrifuge rotor, the second plurality of centrifuge vessels being inserted at the same time.

108. The method of claim 85, wherein the sample is a fermentation sample.

109. The method of claim 85, comprising:
robotically inserting a plurality of sample vessels into the clusters; and,
robotically inserting a group of sample processing components into at least one selected cluster and performing a sample processing operation with the sample processing components.

110. The method of claim 85, comprising robotically removing a group of sample processing components from a first cluster, rotating the rotor until a second cluster is proximal to the sample processing components, re-inserting the sample processing components into a second cluster and again performing the same sample processing operation or a different sample processing operation on samples in the second cluster.

111. The method of claim 85, comprising robotically inserting a cell pellet removal component which removes a cell pellet from at least one of the sample vessels.

112. An automated method of claim 111, the method further comprising reintroducing supernatant removed from a centrifuge vessel into a corresponding centrifuge vessel.

113. An automated method of claim 112, the method further comprising centrifuging the removed supernatant once reintroduced into the corresponding centrifuge vessels.
